(19) United States
(12) Patent Application Publication
(10) Pub. No.: US 2026/0369437 A1
(43) Pub. Date: Nov. 19, 2026

(54) SOLID-STATE FLUID THERMAL BONDED HEAT PIPE MICRO-REACTOR

(71) Applicant: Westinghouse Electric Company LLC, Cranberry Township, PA (US)

(72) Inventors: David L. STUCKER, Chapin, SC (US); Yuriy ALESHIN, Cayce, SC (US); Cory STANSBURY, Gorham, ME (US); Yasir ARAFAT, Pittsburgh, PA (US); Alex LEVINSKY, Sante Fe, NM (US); Jurie J. VAN WYK, Mars, PA (US)

(73) Assignee: Westinghouse Electric Company LLC, Cranberry Township, PA (US)

(21) Appl. No.: 19/750,831

(22) Filed: Jul. 22, 2026

Related U.S. Application Data
(63) Continuation of application No. 18/057,208, filed on Nov. 19, 2022.

(51) Int. Cl. G21C 15/257; G21C 1/32; G21C 15/02

(52) U.S. Cl. CPC G21C 15/257; G21C 1/32; G21C 15/02

(57) ABSTRACT

Disclosed is a passively cooled nuclear reactor, comprising a heat exchanger and a nuclear reactor core disposed proximal to the heat exchanger. The nuclear reactor core comprising a fuel rod, a heat pipe located proximate to the fuel rod and extending from the nuclear reactor core into the heat exchanger, a moderator monolith configured to house and space the fuel rod and the heat pipe, and a thermal bond material disposed internally throughout the moderator monolith to surround the fuel rod and the heat pipe with the thermal bond material and to facilitate heat transfer from the nuclear reactor core to the heat exchanger.

### CROSS-REFERENCE TO RELTAED APPLICATION

This application is a continuation application claiming priority under 35 U.S.C. § 120 to U.S. Patent Application Serial No. 18/057,208, entitled SOLID-STATE FLUID THERMAL BONDED HEAT PIPE MICRO-REACTOR, filed Nov. 19, 2022, the entire disclosure of which is hereby incorporated by reference herein.

### BACKGROUND

The present disclosure relates to nuclear micro-reactors.

### SUMMARY

In one aspect, the present disclosure describes a passively cooled nuclear reactor. The passively cooled nuclear reactor comprises a heat exchanger and a nuclear reactor core disposed proximal to the heat exchanger. The nuclear reactor core comprising a fuel rod, a heat pipe located proximate to the fuel rod and extending from the nuclear reactor core into the heat exchanger, a moderator monolith configured to house and space the fuel rod and the heat pipe, and a thermal bond material disposed internally throughout the moderator monolith to surround the fuel rod and the heat pipe with the thermal bond material and to facilitate heat transfer from the nuclear reactor core to the heat exchanger.

In another aspect, the present disclosure describes a passively cooled nuclear reactor. The passively cooled nuclear reactor comprises a heat exchanger and a nuclear reactor core disposed proximal to the heat exchanger. The nuclear reactor core comprising a plurality of fuel rods, a plurality of heat pipes extending from the nuclear reactor core into the heat exchanger, a moderator monolith comprising a plurality of apertures. Each one of the plurality of fuel rods is configured to be slidably disposed through a first set of apertures defined by the moderator monolith, wherein each one of the plurality of heat pipes is configured to be slidably disposed through a second set of apertures defined by the moderator monolith. The nuclear reactor core further comprises a reflector surrounding the moderator monolith and a thermal bond material disposed internally throughout the moderator monolith to surround the plurality of fuel rods and the plurality of heat pipes with the thermal bond material and facilitate heat transfer from the nuclear reactor core to the heat exchanger. The nuclear reactor core further comprises a container surrounding the reflector. The passively cooled nuclear reactor further comprises a plurality of control rod drive mechanisms disposed distal to the heat exchanger, wherein each control rod drive mechanism is configured to drive a control rod through the heat exchanger to the nuclear reactor core, and wherein the moderator monolith.

### BRIEF DESCRIPTION OF THE FIGURES

The novel features of the various aspects are set forth with particularity in the appended claims. Throughout the FIGS. like reference characters designate like or corresponding parts throughout the several views of the drawings. The described aspects, however, both as to organization and methods of operation, may be best understood by reference to the following description, taken in conjunction with the accompanying drawings in which:

FIG. 1 is a perspective view of a nuclear micro-reactor, according to at least one aspect of the present disclosure.

FIG. 2 is a perspective view of the nuclear micro-reactor shown in FIG. 1 with the control rod drive mechanisms removed, according to at least one aspect of the present disclosure.

FIG. 3 is a perspective view of the nuclear micro-reactor shown in FIG. 2 with the control rods removed, according to at least one aspect of the present disclosure.

FIG. 4 is a perspective view of the nuclear micro-reactor shown in FIG. 3 with the heat exchanger removed, according to at least one aspect of the present disclosure.

FIG. 5 is a perspective view of the nuclear micro-reactor core shown in FIG. 4 with the heat pipes removed, according to at least one aspect of the present disclosure.

FIG. 6 is a side view of the nuclear micro-reactor shown in FIG. 1, according to at least one aspect of the present disclosure.

FIG. 7 is a cross-sectional view of a nuclear micro-reactor core configuration taken along cross-sectional line 7—7 shown in FIG. 6, according to at least one aspect of the present disclosure.

FIG. 8 is a perspective view of the nuclear micro-reactor core configuration shown in FIG. 7, according to at least one aspect of the present disclosure.

FIG. 9A is a detailed view of the monolith structure shown in FIG. 7, according to at least one aspect of the present disclosure.

FIG. 9B is a detailed view of the monolith structure shown in FIG. 9A, according to at least one aspect of the present disclosure.

FIG. 10 is a perspective view of a unit cell of the nuclear micro-reactor core configuration shown in FIG. 7, according to at least one aspect of the present disclosure.

FIG. 11 is a perspective view of a unit cell of the nuclear micro-reactor core configuration shown in FIG. 7, according to at least one aspect of the present disclosure.

FIG. 12 is a perspective view of a reflector configuration of the nuclear micro-reactor core, according to at least one aspect of the present disclosure.

FIG. 13 is a cross-sectional view of the entire nuclear micro-reactor taken along cross-sectional line 13—13 shown in FIG. 7, according to at least one aspect of the present disclosure.

FIG. 14 is a cross-sectional view of the entire nuclear micro-reactor taken along cross-sectional line 14—14 shown in FIG. 7, according to at least one aspect of the present disclosure.

FIG. 15 is a detailed view of the cross-section of the heat exchanger shown in FIG. 13, according to at least one aspect of the present disclosure.

FIG. 16 is a detailed view of the cross-section of an annular fuel rod shown in FIG. 15, according to at least one aspect of the present disclosure.

FIG. 17 is a cross-sectional view of a nuclear reactor core configuration, according to at least one aspect of the present disclosure.

FIG. 18A is a detailed view of FIG. 17, according to at least one aspect of the present disclosure.

FIG. 18B is a detailed view of FIG. 18A, according to at least one aspect of the present disclosure.

FIG. 19 is a perspective view of a fuel unit cell of the nuclear micro-reactor core configuration shown in FIG. 17, according to at least one aspect of the present disclosure.

FIG. 20 is a perspective view of a fuel unit cell of the nuclear reactor core configuration shown in FIG. 17, according to at least one aspect of the present disclosure.

FIG. 21 is a perspective view of a fuel unit cell of the nuclear reactor core configuration shown in FIG. 17, according to at least one aspect of the present disclosure.

FIG. 22 is a side view of a moderator rod with the outer shell being transparent, according to at least one aspect of the present disclosure.

FIG. 23 is a side view of a moderator rod with the outer shell being transparent, according to at least one aspect of the present disclosure.

FIG. 24 is a side view of a moderator rod with the outer shell being transparent, according to at least one aspect of the present disclosure.

FIG. 25 is a cross-sectional view of the entire nuclear micro-reactor taken along section line 25—25 shown in FIG. 17, according to at least one aspect of the present disclosure.

FIG. 26 is a cross-sectional view of the entire nuclear micro-reactor taken along section line 26—26 shown in FIG. 17, according to at least one aspect of the present disclosure.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are nonlimiting examples, and thus it can be appreciated that the specific structural and functional details disclosed herein may be representative and illustrative. Variations and changes thereto may be made without departing from the scope of the claims. Furthermore, it is to be understood that such terms as “top”, “bottom”, "forward", "rearward", "left", "right", "upwardly", "downwardly", and the other such words are words of convenience and are not to be construed as limiting terms.

Before explaining various aspects of the nuclear micro-reactor in detail, it should be noted that the illustrative examples are not limited in application or use to the details of construction and arrangement of parts illustrated in the accompanying drawings and description. The illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects, and/or examples.

A nuclear micro-reactor according to various aspects of the present disclosure may be configured to serve as an electric power source alternative to high-cost diesel and other fossil sources in off-grid applications where wind and solar plus energy storage is not a viable economic option. In various aspects, the nuclear micro-reactor according to the present disclosure also may be configured to be highly portable such that it can be transported to remote locations where it can provide power or be shut down and ready to move within a short period. Aspects of the nuclear micro-reactor according to the present disclosure also may be configured to provide a secure and hardened source for on-grid electricity applications where the potential for extended blackout due to loss of grid integrity is unacceptable. Other aspects of the nuclear micro-reactor according to the present disclosure also may be configured to operate autonomously, without a permanently-based operations or maintenance staff to support normal power operations, and with a core lifetime of at least three years. Further, additional aspects of the nuclear micro-reactor according to the present disclosure may be configured to be air-cooled, thus eliminating the need for a cooling water source and emergency planning outside a double fence that typically defines a nuclear reactor site boundary. These characteristics enable aspects of the micro-reactor according to the present disclosure to replace high-cost fossil fuel generators in near and off-grid applications while retaining production reliability and eliminating fossil fuel-related pollution and carbon emissions.

Additional aspects of the nuclear micro-reactor according to the present disclosure may be a solid state, passively-cooled, heat pipe reactor. In a heat pipe reactor implementation, the fuel (both solid and annular), heat pipes, graphite moderator, and optional metal hydride moderator elements can be mechanically free-standing and are all thermally-bonded to each other with a variety of fluids including, but not limited to gasses such as helium, argon, or carbon dioxide; liquid metals such as molten lead, tin, or molten lead/bismuth; or molten salts such as fluorine/lithium/beryllium (FLiBe). In various aspects, the thermal bonding is in a pool of liquid thermal bond material. Aspects of the liquid thermal-bonding may be employed in a vertical orientation with a guard vessel to preclude the remote potential for a loss of coolant due to reactor vessel failure. Aspects of the liquid thermal-bonding offer atmospheric pressure operation, high power conversion operating temperatures combined with low fuel operating temperatures while providing passive, failure proof graphite coverage to prevent oxidation. Atmospheric pressure operation corresponds to pressures that range from 30 kPA to 103 kPa. In an alternative aspect, a gas thermal bonding material is used. A gas-thermally-bonded reactor is advantageous because it is not restricted in terms of physical orientation notwithstanding being pressurized during operation.

Fuel materials for aspects of the nuclear micro-reactor described herein encompass the entire range of currently available materials including, but not limited to, oxide, carbide, uranium nitride, uranium nitride-silicide, and/or plutonium. In addition, tri-structural isotropic particle fuel (TRISO) materials are also applicable to the nuclear micro-reactor described herein and offer particularly favorable high temperature fission product containment. The advantages of TRISO become attractive when the gas thermal bonding aspects of the nuclear micro-reactor described herein are considered. One of the disadvantages of TRISO is the use of significantly higher enrichment fuel material than oxide, carbide, silicide, or nitride ceramic fuels.

In one example, a passively cooled nuclear micro-reactor may include a heat exchanger and a nuclear reactor core disposed proximal to the heat exchanger. The nuclear reactor core may include fuel rods, heat pipes, a moderator monolith configured to house and space the fuel rods and the heat pipes, and a thermal bond material applied internally throughout the moderator monolith to surround the fuel rods and heat pipes with the thermal bond material and facilitate heat transfer from the nuclear reactor core to the heat exchanger.

In one aspect, the thermal bond material is configured to operate at temperatures limited by the nuclear reactor material of construction. A guard vessel may be provided to contain any liquid thermal bond material that might leak during a nuclear reactor vessel failure. The guard vessel and nuclear reactor vessel clearances are sized so that the liquid thermal bond material level will remain sufficiently above the graphite to preclude oxidation and above the fuel to preclude heat transfer degradation, while eliminating the possibility of a loss of coolant accident. Heat for the intended operating process is extracted from the nuclear reactor through the heat pipes via a primary heat exchanger located directly above the nuclear reactor for liquid thermal bond materials and adjacent to the nuclear reactor for gas thermal bond materials. The primary heat exchanger isolates the heat pipe working fluid contaminated through exposure to the nuclear reactor neutron field during the power conversion process and/or heat transfer working fluid (liquid or gas) on the clean side of the primary heat exchanger when the nuclear reactor is producing nuclear heat. The fluid (liquid or gas) pressures in the primary heat exchanger are such that the contaminated primary fluid cannot leak into the power conversion fluid (liquid or gas) because the power conversion pressure is always higher than the heat pipe pressure. Shutdown decay heat is extracted from the reactor either through the heat pipes to the ultimate heat sink under normal conditions or through natural convection air and/or water assisted cooling of the reactor vessel.

In an annular fuel implementation of the nuclear micro-reactor, annular fuel elements are positioned within the nuclear micro-reactor to transfer nuclear heat bi-directionally into the thermal bond material through the fuel rod outer diameter and directly to the primary heat exchanger through a heat pipe located within the inner diameter of the annular fuel rod element. Heat transferred from an outer diameter of the annular fuel element and any outer diameter of solid fuel rod elements provides the heat source for the graphite moderator to transfer heat to the non-fuel heat pipes. Optional metal hydride moderator reactor elements will operate at a roughly isothermal condition between the temperature of the outer diameter of the fuel rod and the temperature of the non-fuel heat pipe. In a solid fuel implementation of the nuclear micro-reactor, the solid fuel element transfers nuclear heat from fuel pellets through the outer diameter of the fuel rod into the thermal bond material and from the thermal bond material to the graphite moderator and then to non-fuel heat pipes.

In various aspects, the nuclear micro-reactor according to the present disclosure is configured to operate autonomously and inherently self-limiting in terms of both maximum power output and operating temperature through a unique combination of fuel and feedback mechanisms. The fuel may be enriched at levels below that of high enrichment uranium (HEU) and will therefore contain a substantial amount of fertile fuel material such as 238U or 232Th, both of which have significant resonance absorption. The presence of a substantial amount of resonance absorption from the fertile material within the fuel assures there is always a significant and prompt negative Doppler thermal feedback. Additionally, the combination of graphite and optional metal hydride moderators work together to limit the maximum steady-state operating temperature as a function of nuclear reactor power level. Burnable absorbers may be disposed within the nuclear reactor to limit the available excess reactivity as a function of core lifetime. Reactivity control enables the limitation on the reactivity control system such that a worst case malfunction of this control system is safely compensated by the inherent negative Doppler and solid moderator power/temperature feedback. In one aspect, the reactivity control system utilizes strong absorbers that are inserted into the core and/or reflector region of the nuclear reactor. The control absorbers provide the diverse reactivity control necessary to affect safe reactor shutdown at ambient conditions throughout core lifetime.

In one aspect, the nuclear micro-reactor described herein is a solid state, fully passive reactor utilizing heat pipes for nuclear heat transport. The heat pipes eliminate the need for active heat transport components such as pumps and valves, thereby greatly simplifying the configuration and construction of the nuclear micro-reactor. The only moving parts in the nuclear micro-reactor are the control elements of the reactivity control system. The fully passive operational, shutdown, and upset cooling of the nuclear micro-reactor enables the wholesale elimination of complete safety systems, as employed in conventional nuclear reactors, to reduce the cost and operational complexity of the nuclear micro-reactor described herein. In one aspect, the nuclear micro-reactor may be configured to operate without the need for 24/7 operators due to the simplicity of the nuclear micro-reactor, reactor protection requirements, and the ability of the liquid thermal bonding pool and reactor containment structures to retain large portions of fission products that might be released from the fuel due to a defect, or as a result of a reactor transient. In various aspects, the nuclear micro-reactor according to the present disclosure makes it more cost effective than conventional nuclear reactors.

### Nuclear Micro-Reactor

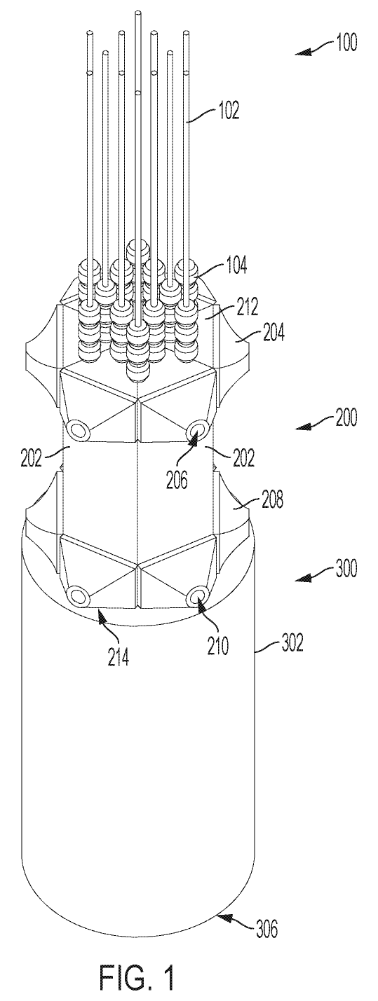

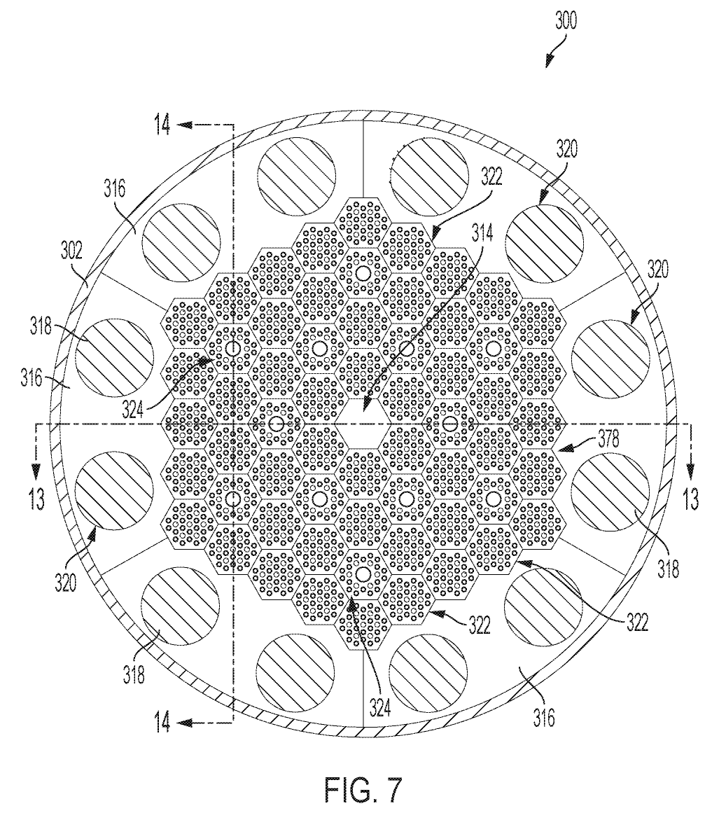

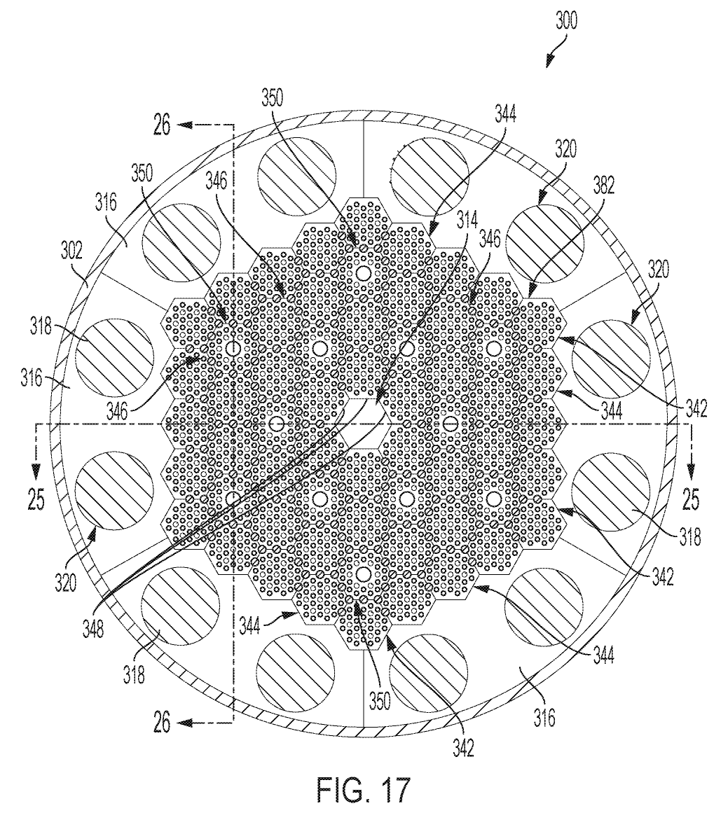

FIGS. 1-26 depict one aspect of a nuclear micro-reactor 100, where FIGS. 7-11, 13, and 15 show a first internal nuclear core configuration, FIGS. 17-26 show a second internal nuclear core configuration, and FIGS. 1-6, 12, 14, and 16 apply to both nuclear core configurations. The difference between the two internal core configurations is that the second internal core configuration shows an example configuration adding additional channels for optional moderator rods.

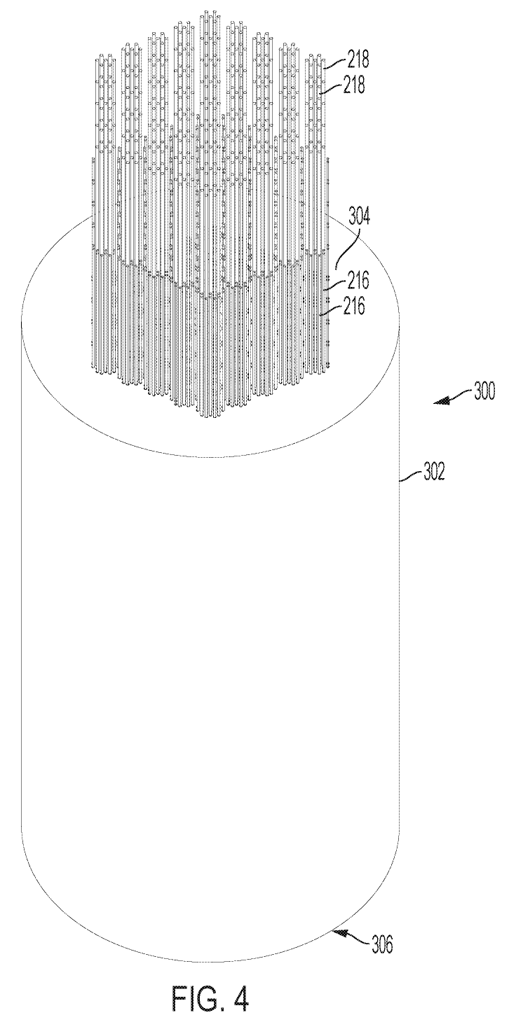

FIG. 1 is a perspective view of a nuclear micro-reactor 100, according to at least one aspect of the present disclosure. The nuclear micro-reactor 100 includes a nuclear micro-reactor core 300, a heat exchanger 200 attached to the nuclear micro-reactor core 300, and control rod drive mechanisms 104 attached to the heat exchanger 200. The nuclear micro-reactor core 300 has a container 302 that surrounds and houses the nuclear micro-reactor core 300. A proximal end at a bottom surface 306 of the container 302 rests on the ground. The heat exchanger 200 is attached to a distal surface 304 at a distal end (FIG. 4) of the container 302. The proximal end 214 of the heat exchanger 200 rests against the distal end of the container 302. The control rod drive mechanisms 104 are attached to the distal end 212 of the heat exchanger 200.

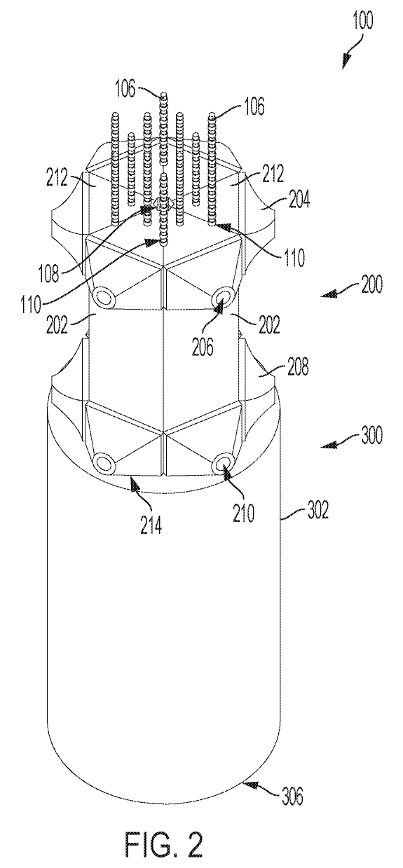

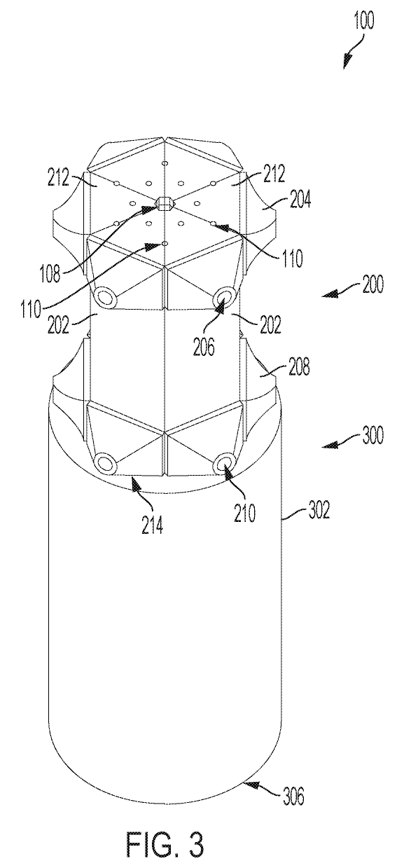

With reference to FIG. 1 together with FIG. 2, each control rod drive mechanism 104 has a housing rod 102 extending distally therefrom. Each housing rod 102 surrounds and houses a reactivity control rod 106 (FIG. 2). The control rods 106 are configured to slide in the housing rods 102 and be driven by the control rod drive mechanisms 104. FIG. 2 is a perspective view of the nuclear micro-reactor 100 shown in FIG. 1 with the control rod drive mechanisms removed, according to at least one aspect of the present disclosure. In FIG. 2, the nuclear micro-reactor 100 is shown with the control rod drive mechanisms 102 removed to show the control rods 106. The control rod drive mechanisms 104 are configured to drive the control rods 106 through channels 110 in the heat exchanger 200 and into the nuclear micro-reactor core 300. FIG. 3 is a perspective view of the nuclear micro-reactor 100 shown in FIG. 2 with the control rods removed, according to at least one aspect of the present disclosure. In FIG. 3 the nuclear micro-reactor 100 is shown with the control rods removed to show the control rod channels 110. The control rods 106 are used to control the fission occurring within the nuclear micro-reactor core 300 and therefore, to prevent the nuclear micro-reactor core 300 from achieving a critical temperature in the event of a reactor and/or power failure or criticality accident.

In various aspects, the heat exchanger 200 is made from multiple heat exchanger sections 202. In one aspect, each heat exchanger section 202 is a fusion-bonded heat exchanger. Additional aspects of the heat exchanger 200 may be made from one component and not a plurality of sections attached together. In various aspects, the heat exchanger 200 passively cools the nuclear micro-reactor core 300. In various other aspects, a fluid (liquid or gas) flows through the heat exchanger 200 to cool the nuclear micro-reactor core 300. Each heat exchanger section 202 has a distal nozzle 204 and a proximal nozzle 208. The distal nozzle 204 defines a hole 206 and the proximal nozzle 208 defines a hole 210. The holes 206, 210 allow a working fluid (liquid or gas) to enter and leave the heat exchanger section 202. In alternative aspects, the heat exchanger 200 may be configured in any suitable geometry or functional implementation to enable a working fluid (liquid or gas) to enter and exit the heat exchanger 200 to passively cool the nuclear micro-reactor core 300. In some aspects, a channel 108 provides an open channel through the middle of the heat exchanger 200. In at least one aspect, the heat exchanger 200 does not have the channel 108.

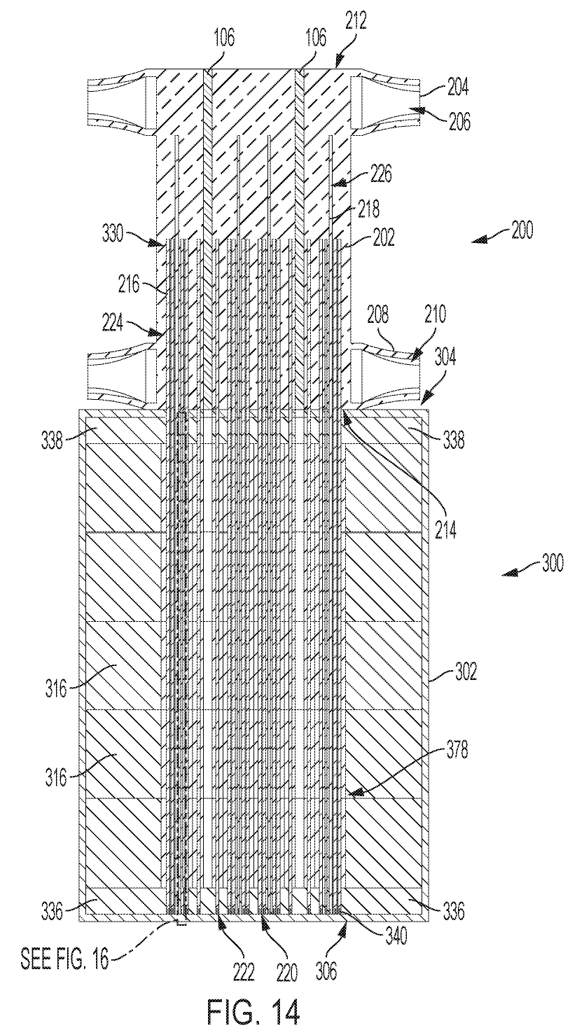

In various aspects, the heat exchanger 200 is thermally connected to the nuclear micro-reactor core 300 through fuel heat pipes 216 and non-fuel heat pipes 218. FIG. 4 is a perspective view of the nuclear micro-reactor 100 shown in FIG. 3 with the heat exchanger removed, according to at least one aspect of the present disclosure. In FIG. 4 the nuclear micro-reactor 100 is shown with the heat exchanger removed to show the fuel heat pipes 216, 218 extending from the nuclear micro-reactor core 300 into the heat exchanger 200. The fuel heat pipes 216 extend through channels 308 defined in the nuclear micro-reactor core 300. Each fuel heat pipe 216 is configured to extend through an inner diameter of an annular fuel rod 330 (FIG. 14) in the nuclear micro-reactor core 300. The non-fuel heat pipes 218 extend through channels 310 defined in the nuclear micro-reactor core 300. The non-fuel heat pipes 218 extend into the heat exchanger 200 farther than the fuel heat pipes 216. This configuration allows the proximal end of the heat exchanger 200 to be heated to a higher temperature than the distal end of the heat exchanger 200. In at least one aspect, a working fluid (liquid or gas) flows through the distal nozzle 204 into the heat exchanger 200 and out through the proximal nozzle 208. This can allow the working fluid (liquid or gas) to achieve a temperature close to the temperature at the proximal end. In an alternative aspect, a working fluid (liquid or gas) flows through the proximal nozzle 208 into the heat exchanger 200 and out through the distal nozzle 204. In at least one aspect, the working fluid (liquid or gas) is air. In an alternative aspect, the working fluid is a liquid.

As the fuel heat pipes 216 and the non-fuel heat pipes 218 heat up during operation of the nuclear micro-reactor 300, the fuel heat pipes 216 and the non-fuel heat pipes 218 thermally connect to the primary heat exchanger due to thermal expansion of the fuel heat pipes 216 and non-fuel heat pipes 218. This leverages the higher temperature of the fuel and non-fuel heat pipes 216, 218 to create a tight thermal and mechanical connection to the primary heat exchanger 200 during operation of the nuclear micro-reactor 100.

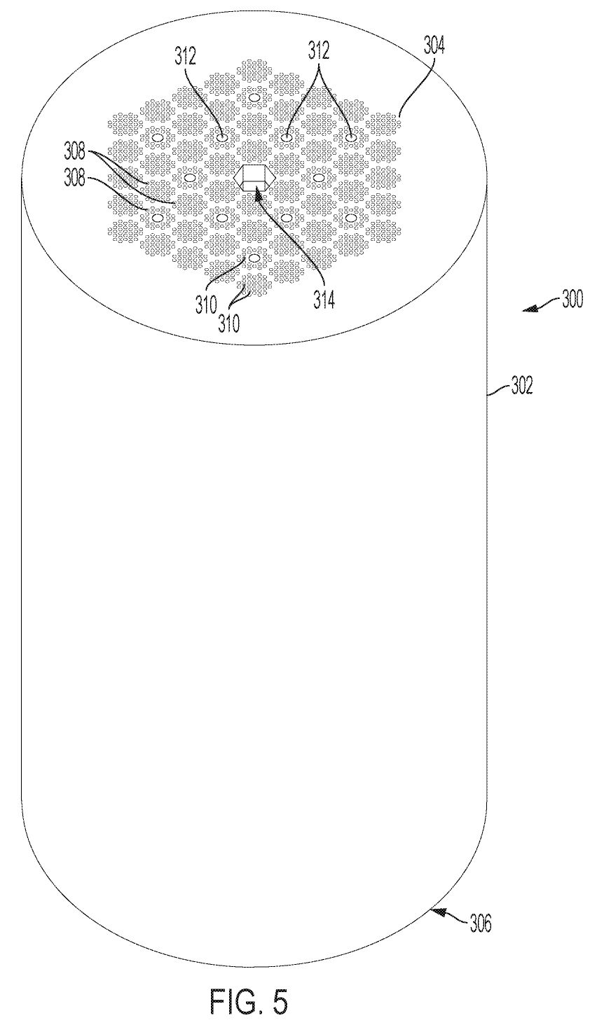

FIG. 5 is a perspective view of the nuclear micro-reactor core 300 shown in FIG. 4 with the heat pipes removed, according to at least one aspect of the present disclosure. In FIG. 5 the nuclear micro-reactor core 300 is shown with the fuel and non-fuel heat pipes 216, 218 removed. The fuel heat pipes 216 are inserted into the container 302 through channels 308. The non-fuel heat pipes 218 are inserted into the container 302 through channels 310. The control rod channels 110 in the heat exchanger 200 line up with control rod channels 312 in the nuclear micro-reactor core 300 creating a single channel in the nuclear micro-reactor 100 that extends through the heat exchanger 200 into the nuclear micro-reactor core 300. Stated another way, each reactivity control rod 106 can be driven through a channel 110 in the heat exchanger 200 and into a channel 312 in the nuclear micro-reactor core 300. The distal surface 304 of the container 302 defines holes for the channels 308, 310, 312, which provide lattice positions for the fuel heat pipes 216, non-fuel heat pipes 218, and control rods 106. In some aspects, the container 302 defines a channel 314 in the center of the top surface 304 to allow gas media to evacuate. For example, the channel 314 lines up with the channel 108 in the heat exchanger 200 to allow gas media to evacuate through the two channels 314, 108. In at least one aspect, the top surface 304 does not have a channel 314. The container 302 is filled with a thermal bond material such that the thermal bond material surrounds all the components of the nuclear micro-reactor core 300. For example, the thermal bond material surrounds the fuel heat pipes 216 and non-fuel heat pipes 218 in their respective channels 308 and 310. In some aspects, the thermal bond material is a liquid thermal bond material. In various alternative aspects, the thermal bond material is a gas thermal bond material.

With reference back to FIG. 4, the fuel can supply nuclear heat into a liquid thermal bond material to create an approximately isothermal heat transfer thermal boundary condition for the outer-diameter of the fuel heat pipes 216, non-fuel heat pipes 218, graphite moderator, and optional metal hydride moderator reactor elements. The liquid-thermal-bond enables large gaps to be defined between components and generous tolerances due to the high thermal conductivity across the liquid bond. In various aspects, the liquid-thermal-bond is situated in a vertical orientation with a guard vessel to preclude loss-of coolant by accident or otherwise. Examples of liquid thermal bonding materials include, but are not limited to molten lead, lead-bismuth eutectic, sodium, potassium, sodium-potassium eutectic, and molten salts such as FLiBe, for example.

Still with reference to FIG. 4, in an alternative aspect, a gas thermal bonding material is utilized. A gas thermal bond enables the nuclear micro-reactor core 300 to be placed in an arbitrary orientation. The size and variability of the gaps defined between fuel, graphite moderator, and fuel and non-fuel heat pipes 216, 218 (and to a lesser extent, solid moderator rods, if used) should be minimized to limit temperature gradients between the fuel rod heat source and heat pipe heat sink. In the presence of a hot graphite moderator, the gas-thermal-bond material will not react with the graphite and will not be a source of adverse radiological or chemical hazard. Examples of potential gas-thermal-bond materials include, but are not limited to helium or carbon dioxide.

With reference now to FIGS. 1-3, the use of a thermal bond material results in minimal thermal stresses induced on the components of the nuclear micro-reactor 100 due to the use of a fluid (liquid or gas) to provide thermal bonding between components of the nuclear micro-reactor 100. The thermal bonding eliminates the complications of individual components mechanically interacting with each other, as is the case in conventional heat pipe reactors, in which the reactor components are thermally-coupled to a solid, generally metallic, structural monolith.

With reference to FIGS. 1-4 together with FIG. 14, in one aspect, the solid state heat pipe nuclear micro-reactor 100 may be configured to use a plurality of annular fuel rods 330 (FIG. 14) as well as solid fuel rods. The temperature at the inner diameter of the annular fuel rod 330 is higher than the temperature at the outer diameter of the annular fuel rod 330. In various aspects, the inner diameter of the annular fuel rod 330 is thermally bonded to a fuel heat pipe 216 to transfer the nuclear heat at the inner diameter of the annular fuel rod 330 to the outer diameter of the annular fuel rod 330. This higher temperature at the temperature at the inner diameter of the annular fuel rod 330 is utilized in the primary heat exchanger 200 to enable higher working fluid temperatures without requiring all the materials of construction and components of the nuclear micro-reactor 100 to tolerate such higher temperatures. The thermal bond material, heated by the annular and solid fuel elements outer diameter, is temperature limited by the material of construction of the nuclear reactor vessel. Conventional materials of construction have been qualified for use at temperatures of about 700°C. A guard vessel is used to catch any liquid thermal bond material that might leak out of a nuclear reactor vessel due to failure and still keep the liquid level above the fuel, thus eliminating or minimizing the possibility of a loss of coolant while keeping the hot graphite moderator protected from oxidation by any potential air ingress. Gas thermal bonding fluids employ techniques to render inert the hot graphite moderator from oxidation by potential air ingress in the unlikely event of vessel failure or gas thermal bonding leakage.

The reactor fuel cycle is initially designed for a Uranium (U):Plutonium (Pu) once-through fuel cycle. However, capability for U:Pu, Pu:U, and Thorium (Th):U recycle fuel cycles also are possible to maximize flexibility for changes in future fuel cycle cost and availability. In various aspects, any nuclear reactor fuel cycle could be used.

With continued reference to FIGS. 1-4 together with FIG. 14, heat for the intended operating process is extracted from the nuclear micro-reactor core 300 through the fuel and non-fuel heat pipes 216, 218 via the primary heat exchanger 200, transferring the reactor heat from the reactor fuel and non-fuel heat pipes 216, 218 to the power conversion system working fluid. The primary heat exchanger 200 transfers nuclear heat from the nuclear micro-reactor core 300 via the fuel and non-fuel heat pipes 216, 218 and isolates the heat pipe working fluid, e.g., Na or NaK (which has been contaminated through exposure to the reactor neutron field), from the power conversion and/or heat transfer working fluid on the clean side of the primary heat exchanger 200. The nuclear micro-reactor 100 utilizes fuel and non-fuel heat pipes 216, 218 that are mechanically and thermally coupled to the primary heat exchanger 200. The nuclear micro-reactor 100 utilizes the primary heat exchanger 200 attached to the inside of the reactor vessel head located at a container distal surface 304 through which the fuel and non-fuel heat pipes 218, 216 extend and insert into the reactor core structure 378 and inner diameter of the annular fuel rod 330, respectively, as the nuclear micro-reactor 100 is assembled. This arrangement enables replacement of the primary heat exchanger 200 and the fuel and non-fuel heat pipes 216, 218 and allows disassembly of the heat transport system from the nuclear micro-reactor core 300. The ability to disassemble the heat transport system from the nuclear micro-reactor core 300 enables access to the annular fuel rods 330 for repair, replacement, or removal. This process can be used for consolidation and permanent disposal or reprocessing. The nuclear micro-reactor 100 utilizes a primary heat exchanger 200 in which the non-fuel heat pipes 218 and the inner diameter of the fuel heat pipes 216 are used for countercurrent heat transfer. In this, the non-fuel heat pipes 218 transfer their heat in the heat exchanger 200 at the thermal bond material temperature to a power conversion working fluid and the inner diameter of the fuel heat pipes 216 transfer their heat in the heat exchanger 200 at the at the higher temperatures available from the inner diameter of the fuel rod 330 to the power conversion working fluid. This configuration allows the power conversion working fluid to approach the higher fuel inner diameter temperature without having to utilize higher temperature-compatible materials throughout the reactor vessel, with the exception of the inner diameter of the fuel heat pipes 216. In at least one aspect, the power conversion working fluid is air.

The annular fuel heat pipes 216 provide a higher temperature to the primary heat exchanger 200 than is available from the liquid thermal bonding pool non-fuel heat pipes 218 thereby limiting the temperature that the reactor vessel and components must withstand. The liquid thermal bonding pool non-fuel heat pipes 218 act as an economizer section within the primary heat exchanger 200 in which the power conversion working fluid is first contacted in a countercurrent fashion with the low temperature pool non-fuel heat pipes 218 followed by the high temperature fuel heat pipes 216. As a result, the power conversion working fluid is provided at the higher temperature available from the inner diameter of the fuel heat pipes 216 without requiring expensive, high-temperature material for large amounts of reactor construction which would be in contact with the liquid thermal bonding pool. In one aspect, the fuel and non-fuel heat pipes 216, 218 are phase change heat pipes, in which the heat pipe working fluid, typically Na or NaK, is evaporated in the reactor region at sub-atmospheric pressure and transported by convection to the condenser region within the primary heat exchanger 200, where it is condensed and passively returned to the reactor region by gravity and capillary wick action.

With reference now to FIG. 14, in various aspects, the core structure monolith 378 is made of graphite. In some alternative aspects, the alternative materials can serve as the core structure monolith 378. The primary purpose of the core structure monolith 378 is to provide alignment of the fuel, non-fuel heat pipes, and optional moderator rods. The core structure monolith 378 is mechanically isolated, but thermally bonded to the other reactor components through the use of a fluid thermal bonding material 326.

Reactor disassembly and refurbishment is envisioned to be performed at a purpose-designed facility that has specific equipment to enable reactor disassembly, repair, refurbishment, fuel handling and consolidation, reactor reassembly, or disposal of reactor components that have reached end of useful life. Shutdown decay heat is extracted from the reactor either through the heat pipes to the ultimate heat sink under normal conditions, or through natural convection air and/or water assisted cooling of the reactor vessel when heat transfer through the primary heat exchanger is not available.

With reference back to FIGS. 1-4 together with FIG. 14, the nuclear micro-reactor 100 utilizes control rod assemblies that insert into lattice points within the graphite core structure monolith 378 and/or reflector region and extend upward through the primary heat exchanger 200 to drive mechanisms 104 located at the top 212 of the reactor vessel head. The control rod assemblies are configured to limit the reactivity in the event of inadvertent positioning of the control rod assemblies. The nuclear micro-reactor 100 utilizes fixed burnable absorbers designed to enable full power operation at all times during core lifetime while limiting the core excess reactivity that must be controlled with control rod assemblies. The nuclear micro-reactor 100 utilizes fuel in an annular fuel/heat pipe configuration with the fuel heat pipe 216 as the inner diameter of the annular fuel rod 330 and potentially, additional solid fuel rods. Each annular fuel pellet is thermally bonded to the inner and outer tubes with a liquid thermal bonding pool to eliminate heat transfer through gas gaps and the associated high fuel temperatures, thermal stresses, and fission gas release. The outer diameter of the annular bonded fuel/heat pipe combination is immersed in the liquid thermal bonding pool to thermally bond the graphite and optional metal hydride solid moderators as well as additional non-fuel heat pipes 218. Alternate embodiments using separate fuel rods without annular fuel and heat pipes also are applicable. Liquid thermal bonding the fuel pellet to the cladding, whether annular or solid, greatly simplifies the fuel rod design and enables the use of conventional uranium dioxide fuel. This obviates the need to develop the infrastructure for new fuel material forms. The bonded fuel/heat pipe combination is provided with an offset in the fuel heat pipe 216 above the active core elevation to eliminate neutron/gamma beaming that would otherwise irradiate the primary heat exchanger located above the reactor.

Liquid thermal bonding of the fuel to the fuel heat pipes 216 and reactor vessel provides the following technical advantages. First, thermal stresses within the reactor components are eliminated or minimized due to the conduction heat transfer afforded by the liquid thermal bonding pool. Liquid thermal bonding results in nearly isothermal boundary conditions for each of the reactor components. Reducing component stress and fatigue will extend the useful life of the components to enable plant lifetime extension beyond a currently-envisioned eight to ten years. Second, thermally bonding the fuel to the liquid thermal bonding pool and high conductivity graphite monolith eliminates or minimizes the potential for local fuel hot spots due to the failure of adjacent heat pipes 216, 218, as well as reactor structure stresses that would occur without the fuel being thermally bonded to the liquid thermal bonding pool and graphite monolith. Third, eliminating or minimizing the concern about individual heat pipes 216, 218 failure also eliminates the need for complex, safety-related, radiation-hardened heat pipe instrumentation to protect the reactor against inadequate fuel cooling. Simple measurement of the liquid thermal bonding pool temperature could provide an accurate measure of the thermal boundary conditions for all of the fuel within the reactor. Fourth, vertically orienting the nuclear micro-reactor 100 enables the use of thermosiphon heat pipes which could increase the heat pipe 216, 218 energy transport capability and thereby reduce the size of the nuclear micro-reactor 100. Fifth, liquid thermal bonding provides thermal inertia which limits the safety implications of temperature change due to power mismatch transients, which results in a simple control system design to provide stable operation. Sixth, the liquid thermal bonding pool eliminates or minimizes graphite oxidation or runaway Wigner energy heat transfer. Lastly, the use of high-A number liquid thermal bonding materials (e.g., lead) provides a low cost, very effective reactor biological shield.

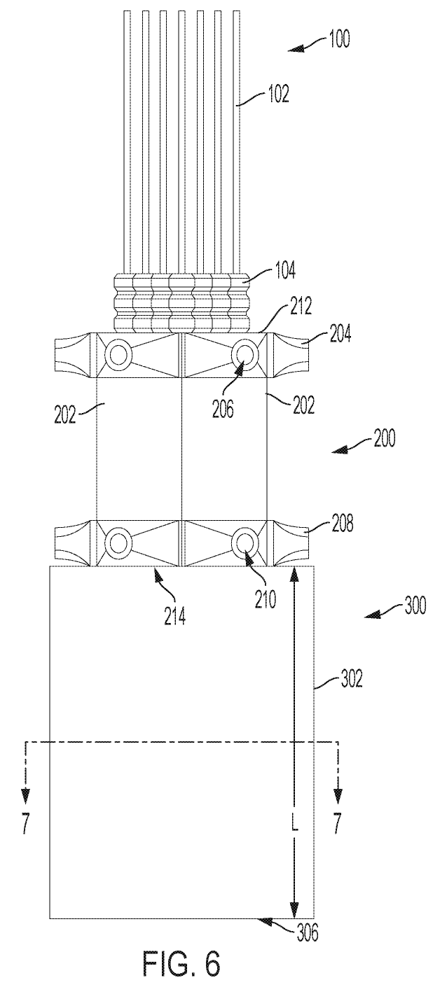

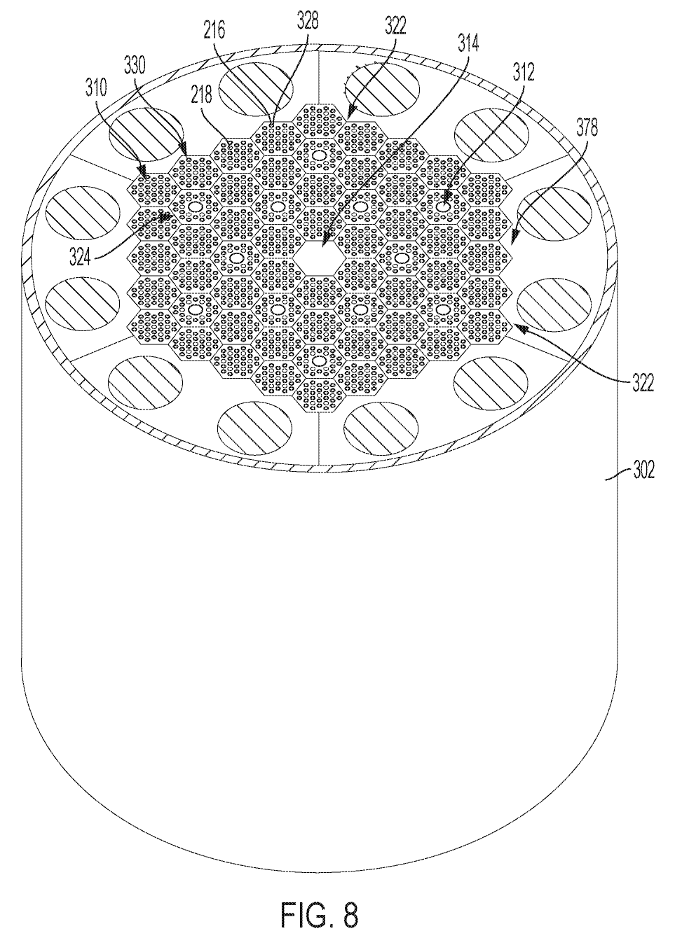

Referring now to FIGS. 6-8, FIG. 6 is a side view of the nuclear micro-reactor 100 shown in FIG. 1, according to at least one aspect of the present disclosure. The nuclear micro-reactor core 300 extends along an axial direction, which defines a length L of the nuclear micro-reactor core 300. Turning to FIG. 7, there is shown a cross-sectional view of the nuclear micro-reactor core 300 configuration taken along the cross-sectional line 7—7 as shown in FIG. 6, according to at least aspect of the present disclosure. In FIG. 8, there is shown a perspective view of the nuclear micro-reactor core 300 configuration shown in FIG. 7, according to at least one aspect of the present disclosure. FIGS. 7 and 8 show the internal components of the nuclear micro-reactor core 300, which includes a plurality of unit cells 322 and reactivity control cells 324. The unit cells 322 are configured to accommodate the fuel and non-fuel heat pipes 216, 218 and fuel in any configuration (e.g., stacks and/or rods), which can collectively generate nuclear power and manage thermal energy throughout the nuclear micro-reactor core 300. The reactivity control cells 324 are configured to accommodate heat pipes 216, 218, fuel, and control rods 106. In various aspects, one or more unit cells 322, 324 can further include a moderator configuration, which can slow down neutrons emitted from the fuel rod configuration. As depicted in the non-limiting aspect shown in FIG. 7, the unit cells 322, 324 are arranged such that the core structure 378 includes an overall hexagonal geometry, however, in other non-limiting aspects, the unit cells 322, 324 can be arranged such that the core structure 378 includes any one of a number of different geometrical configurations, depending on intended application and/or user preference.

With continued reference to FIGS. 6-8 together with FIG. 2, each reactivity control cell 324 is configured to accommodate a reactivity control rod 106 (FIG. 2), which can collectively work to control the fission occurring within the nuclear micro-reactor core 300 and therefore, prevent the nuclear micro-reactor core 300 from achieving a critical temperature in the event of a reactor and/or power failure or criticality accident. According to various non-limiting aspects, the amount of fission can be reduced or completely eliminated within the nuclear micro-reactor core 300, the latter of which can shut the core down. The reactivity control rods 106 contemplated by the present disclosure include a neutron absorbing material and can be configured to be inserted into the reactivity control cells 324 to slow and/or stop the nuclear reactions in the case of an emergency.

The nuclear micro-reactor core 300 further includes a reflector 316 shield. For example, the reflector 316 includes one or more plates composed of a thick, neutron-shielding material and configured to substantially surround the nuclear micro-reactor core 300. The reflector 316 further includes a plurality of control drums 318 configured to house a neutron absorptive material. Each control drum 318 is inserted into a reflector 316 through channel 320. In the event of a reactor and/or power failure, the control drums 318 turn inward towards the nuclear micro-reactor core 300 such that the absorptive material mitigates radiation and control the temperature of the nuclear micro-reactor core 300. According to some non-limiting aspects, the reflector 316 can additionally and/or alternatively include a gamma shield configured to further mitigate radiation in the event of a failure.

The plurality of unit cells 322 and the plurality of reactivity control cells 324 can be particularly arranged to establish a hexagonal configuration of the non-limiting aspect of the nuclear micro-reactor core 300. It is also evident that each unit cell 322 and each reactivity control cell 324 can include a hexagonal configuration as well. Those skilled in art, however, will appreciate that the hexagonal configuration is exclusively depicted for illustrative purposes. Accordingly, the present disclosure contemplates other non-limiting aspects in which the unit cells 322, 324 include any number of geometrical configurations (e.g., square, circular, triangular, rectangular, pentagonal, octagonal, etc.) and arranged such that the nuclear micro-reactor core 300 can include any number of geometrical configurations.

In further reference of FIG. 7, the plurality of unit cells 322 and the plurality of reactivity control cells 324 are arranged along a radial direction. Specifically, the non-limiting aspect shown in FIG. 7 depicts a nuclear micro-reactor core 300 with 48 fuel unit cells 322 and 12 control unit cells 324. However, the present disclosure contemplates other non-limiting aspects wherein the nuclear micro-reactor core 300 includes any number of fuel unit cells 322 and control unit cells 324. In fact, the ability to easily add or subtract the number of unit cells 322, 324 to the nuclear micro-reactor core 300 without dramatically altering its design allows the nuclear micro-reactor core 300 to be easily scaled depending on the intended application and/or user preference. As such, the output of the nuclear micro-reactor core 300 design also can be adjusted for a multitude of applications and requirements. Since the unit cells 322, 324 are configured to accommodate fuel including radioactive isotopes, increasing or decreasing the number of unit cells 322, 324 can alter the output of the nuclear micro-reactor core 300.

It shall be appreciated that the term "radial", as used in the present disclosure, describes any direction extending from the center of the nuclear micro-reactor core 300 when viewed from the top. Accordingly, the use of the term "radial" shall not be limited to circular or circular-like configurations and shall not be construed to imply that the nuclear micro-reactor core 300 is limited to circular, or circular-like, configurations. For example, the present disclosure contemplates non-limiting aspects in which the nuclear micro-reactor core 300 includes a rectangular configuration. According to such aspects, the nuclear micro-reactor core 300 can include one or more radial dimensions of varying lengths.

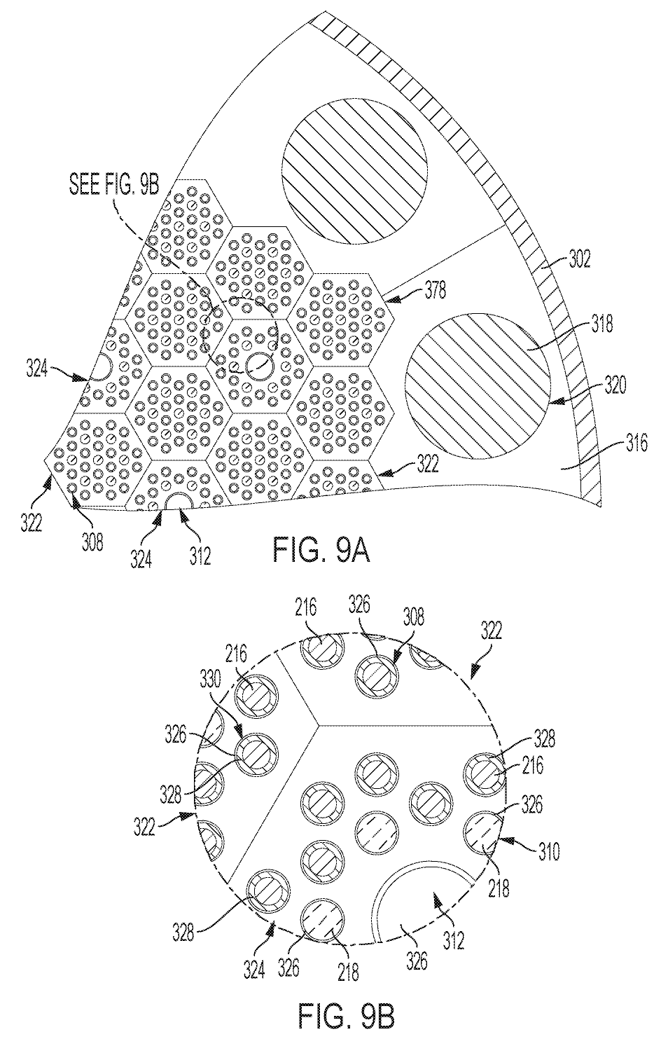

FIG. 7 is a cross-sectional view of a nuclear micro-reactor core 300 configuration taken along cross-sectional line 7--7 shown in FIG. 6, FIG. 8 is a perspective view of the nuclear micro-reactor core 300 configuration shown in FIG. 7, FIG. 9A is a detailed view of the monolith structure shown in FIG. 7, and FIG. 9B is a detailed view of the monolith structure shown in FIG. 9A, according to at least one aspect of the present disclosure. Referring now to FIGS. 7-9B, the plurality of unit cells 322 and the plurality of reactivity control cells 324 can be integrally formed from a solid block of material (e.g., graphite). Thus, the internal features of each of the cells 322, 324, such as heat pipe channels, fuel rod channels, moderator channels, and/or the like, can be bored out of-and integrally formed from-the solid block of material. However, according to other non-limiting aspects, each unit cell 322 of the plurality of unit cells 322 and each reactivity control unit cell 324 of the plurality of reactivity control unit cells 324 can be modularly formed and integrated into the core block to promote the adjustability of the core design. Regardless, the nuclear micro-reactor core 300 can be manufactured to include any number of fuel unit cells 322 and/or reactivity control unit cells 324. This allows the configuration of the nuclear micro-reactor core 300 to be scalable. For example, altering the number of unit cells 322 and reactivity control cells 324 allows the user to alter the radial dimension and length of the nuclear micro-reactor core 300, thereby altering its output and flexibility for applications with unique output and/or space constraints. However, the nuclear micro-reactor core 300 configuration essentially remains the same, which allows for predictability in production and performance regardless of the difference in output and size. These features also reduce the amount of non-recurring engineering required to design for a new application and facilitates manufacturing consistency and the standardization of parts. Although the nuclear micro-reactor core 300 can be scaled as a means of adjusting its output, the scaling should further consider the power rating of the implemented heat pipes, the appropriate number of reactivity control rods required for the adjusted output, and the effectiveness of the control drums.

In further reference to FIGS. 7-9, each of the cells 322 and 324 is configured to be self-sufficient. It shall be appreciated that the term "self-sufficient", as used in the present disclosure, describes the ability of each unit cell 322 or control cell 324 to independently dissipate heat generated by the fuel oriented within the unit cell 322 or control cell 324 via heat rods. The unit cells 322 and control cells 324 are arranged such that the thermal bond material 326 is between them. Accordingly, in the event of a failure of one or more heat pipes within any given cell 322, 324, the adjacent cells 322, 324 will transfer the excess heat away from the nuclear micro-reactor core 300. Thus, the cells 322, 324 are configured to ensure that the nuclear micro-reactor core 300 can operate at an acceptable temperature, even when a cell is no longer self-sufficient due to heat pipe failure.

FIG. 9A is a detailed view of the monolith structure 378 shown in FIG. 7 and FIG. 9B illustrates a detailed view of the monolith structure 378 shown in FIG. 9A, according to at least one aspect of the present disclosure. The fuel rod unit cells 322 and control rod unit cells 324 include a plurality of fuel channels 308 configured to accommodate fuel rods of the nuclear micro-reactor core 300 and a plurality of heat pipe channels 310 configured to accommodate a non-fuel heat pipe 218 of the nuclear micro-reactor core 300. In some aspects, each fuel rod 330 is configured to have a fuel heat pipe 216 insert through the fuel rod 330. Specifically, each fuel rod unit cell 322 includes twenty-four fuel channels 308 and seven heat pipe channels 310. However, it shall be appreciated that the fuel rod unit cell 322 and/or control rod unit cell 324 can include any number of fuel channels 308 and heat pipe channels 310 to optimize the generation of nuclear energy and enhance the efficiency by which thermal energy is removed from the nuclear micro-reactor core 300. In various aspects, the size of the fuel rod channels 308 are the same size as the non-fuel heat pipe channels 310. In some alternative aspects, the size of the fuel rod channels 308 are different than the size of the non-fuel heat pipe channels 310.

The fuel rods 330 are configured to be inserted into a first set of channels 308 in the monolith structure 378 and the non-fuel heat pipes 218 are configured to be inserted into a second set channels 310 in the monolith structure 378. In various aspects, the monolith structure 378 is created from the fuel rod unit cells 322 and control rod unit cells 324. In some aspects, the fuel rods 330 are annular fuel rods where the fuel comes from pellets 328 inserted into an external cladding 333 of the fuel rod 330. The fuel heat pipe 216 is inserted into a channel 380 going through the fuel rod 330. The detailed view of FIG. 9B shows pellets 328 surrounding fuel heat pipes 216 both inserted into the first set of channels 308. In an alternative aspect, the fuel rods have solid fuel pellets and a fuel heat pipe 216 is not inserted through the fuel rod. A thermal bond material 326 surrounds everything in the container 302. For example, the thermal bond material 326 is found between the fuel heat pipes 216 and the fuel rods 330 as well as surrounding the non-fuel heat pipes 218 in the second set of channels 310 and the fuel rods 330 in the first set of channels 308. The thermal bond material 326 is also located between the unit cells 322, 324. Additionally, the control rod channels 312 that allow the control rods 106 to be inserted into the monolith structure 378 include the thermal bond material 326 located within the control rod channels 312. When a reactivity control rod 106 (FIG. 2) is inserted into a control rod channel 312, the thermal bond material 326 is displaced to allow the reactivity control rod 106 to enter the channel. Once the reactivity control rod 106 is inserted into the control rod channel 312, the thermal bond material 326 surrounds the reactivity control rod 106.

With reference now to FIGS. 9A and 9B together with FIGS. 1-3, in various aspects, the thermal bond material 326 may change state during operation of the nuclear micro-reactor 100 (FIGS. 1-3). The thermal bond material 326 may be in a first state during initial operation of the nuclear micro-reactor 100, in a second state during operation of the nuclear micro-reactor 100, and in a third state after the nuclear micro-reactor 100 is shutdown. For example, the thermal bond material 326 could be lead that changes from a solid state prior to operation of the nuclear micro-reactor 100 to a liquid state during operation. For example, the heat generated by the nuclear micro-reactor 100 into the thermal bond material 326 of lead could melt the solid lead into liquid lead. In various aspects, once the nuclear micro-reactor 100 shuts down and cools off the liquid lead thermal bond material 326 solidifies. This process of the thermal bond material 326 being solid when the micro-reactor is not running is advantageous for holding the different internal components of the nuclear micro-reactor core 300 in place. For example, this process is beneficial for transporting the micro-reactor.

As previously discussed, each cell 322, 324 is configured to be self-sufficient. Accordingly, each heat pipe channel 310 is surrounded by several fuel channels 308 of the nuclear micro-reactor core 300, such that thermal energy generated by fuel inserted within the fuel channels 308 is effectively transferred away from the nuclear micro-reactor core 300. For example, the fuel can include neutron emitting materials (e.g., Uranium Oxide, Tri-structural Isotropic Particle Fuels with Uranium Nitride or Uranium Oxycarbide kernels).

In various aspects, the unit cells 322, 324 can further include moderator channels configured to accommodate moderators (e.g., a hydride based moderator, BeO, etc.) of the nuclear micro-reactor core 300, wherein the moderator is configured to retard and suppress the propagation of neutrons emitted by fuel inserted in the plurality of fuel channels 308. FIGS. 17-26 describe one example of adding moderator channels to the nuclear micro-reactor core 300.

With reference back to FIGS. 9A, 9B together with FIGS. 1-3, in some aspects, the unit cells 322, 324 also can include features configured to accommodate neutron absorbing materials that slow the nuclear reactions occurring in the fuel rod channels 308 of the unit cells 322, 324. Accordingly, the power distribution and radial power peaking of the unit cells 322, 324 and consequentially, the nuclear micro-reactor core 300 itself can be further adjusted via the influence of neutron absorbers.

Alternatively and/or additionally, the unit cells 322, 324 can include additional features, configured to accommodate other instrumentation of the nuclear micro-reactor core 300.

As depicted in FIGS. 7-9, the reflector 316 is arranged in a circular configuration that surrounds the hexagonally arranged monolith structure 378. However, in other non-limiting aspects, the reflector 316 can be arranged to form any of a number of different geometrical configurations about the plurality of unit cells 322, 324, depending on intended application and/or user preference.

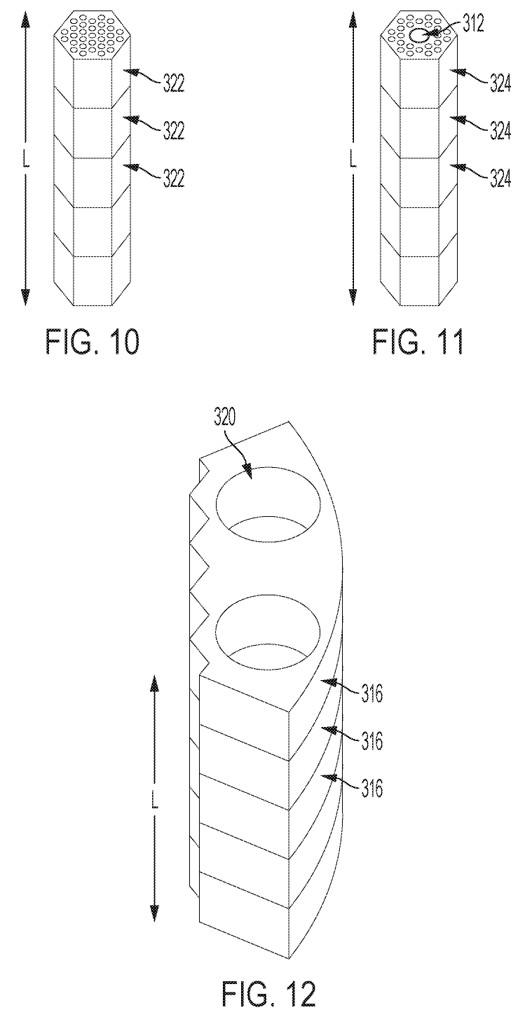

FIG. 10 is a perspective view of a unit cell 322, 324 of the nuclear micro-reactor core 300 configuration shown in FIG. 7, FIG. 11 is a perspective view of a unit cell 322, 324 of the nuclear micro-reactor core 300 configuration shown in FIG. 7, and FIG. 12 is a perspective view of a reflector 316 configuration of the nuclear micro-reactor core 300, according to at least one aspect of the present disclosure. Referring now to FIGS. 10-12, in one aspect the reflectors 316, fuel unit cells 322, and control rod unit cells 324 are configured to span at least a portion of the length L of the nuclear micro-reactor core 300. Due to the unit cells 322, 324 configuration to accommodate fuel, the magnitude of the length L of the nuclear micro-reactor core 300 can correspond to a desired output of the nuclear reactor. For example, each unit cell 322, 324 can be modularly formed and integrated into the core block. The reflector 316 configuration depicted in FIG. 12, for example, includes a plurality of reflectors 316 including control drum channels 320, wherein the reflectors 316 are configured to extend along at least a portion of the length L of the nuclear micro-reactor core 300. In some aspects, the reflector 316 can be integrally formed.

In one aspect, the reflector 316 includes a plurality of control drums 318 configured to house a neutron absorbing and reflective materials. Each control drum 318 is located in the channel 320 on the reflector 316. In the event of a reactor and/or power failure or reactor shut down, the control drums 318 turn inward towards the nuclear micro-reactor core 300 to enable the absorbing material to shut down the nuclear micro-reactor core 300. Additionally, the reflector 316 can further include a gamma shield configured to substantially surround the reflectors 316, the nuclear micro-reactor core 300, and its internal components to further mitigate radiation. In various aspects, the gamma shield is located between the reflectors 316 and the inside of the container 302.

In various aspects, the nuclear micro-reactor 100 is configurable for a wide variety of applications, many of which might have size and/or weight constraints. Therefore, the configuration of the nuclear micro-reactor core 300 allows for the length L to be specifically configurable to accommodate for the output, size, and/or weight requirements of the nuclear reactor.

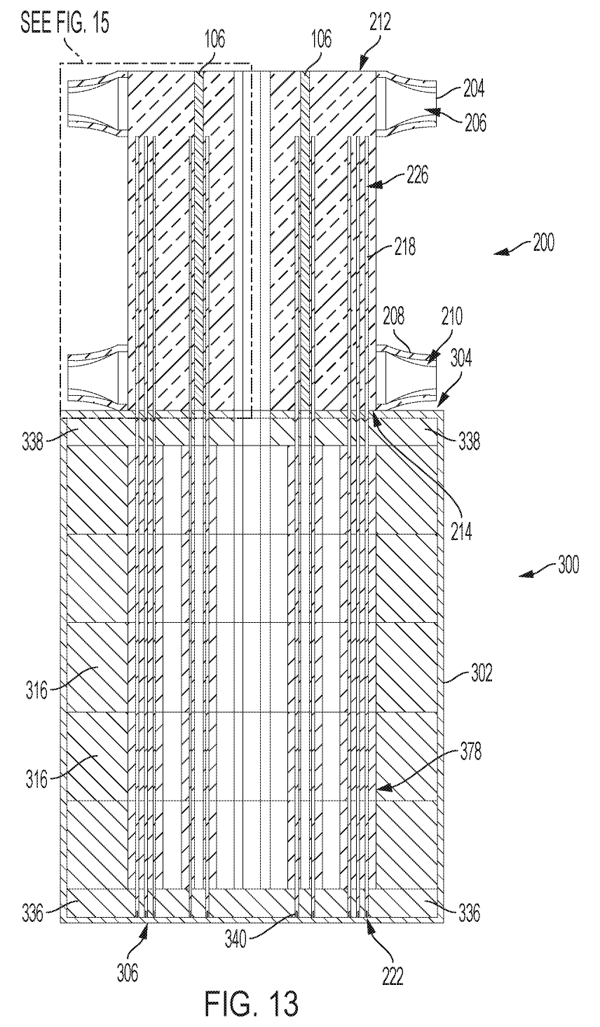

FIG. 13 is a cross-sectional view of the entire nuclear micro-reactor 100 taken along cross-sectional line 13—13 shown in FIG. 7 and FIG. 14 is a cross-sectional view of the entire nuclear micro-reactor 100 taken along cross-sectional line 14—14 shown in FIG. 7, according to at least one aspect of the present disclosure. With reference now to FIGS. 13 and 14, rods 340 extend into the container 302 from the bottom 306 of the container 302. Each non-fuel heat pipe 218 defines a slot 222 that matingly couples with one of the rods 340. Each fuel heat pipe 216 defines a slot 220 that also matingly couples with one of the rods 340. The rods 340 help hold the fuel heat pipes 216 and the non-fuel heat pipes 218 in place. The fuel heat pipes 216 and the non-fuel heat pipes 218 extend through the bottom reflector 336, the core structure monolith 378, the top reflector 338, and the top 304 of the container 302 into the heat exchanger 200. Each non-fuel heat pipe 218 extends through a channel 310 in the nuclear micro-reactor core 300. The channel 310 extends through the bottom reflector 336, the core structure monolith 378, the top reflector 338, and the top 304 of the container 302. When the heat exchanger 200 is placed against the top 304 of the nuclear micro-reactor core 300, the channel 226 in the heat exchanger 200 aligns with the channel 310 in the nuclear micro-reactor core 300. This allows the non-fuel heat pipe 218 to extend through the channel 310 in the nuclear micro-reactor core 300 and into the channel 226 in the heat exchanger 200.

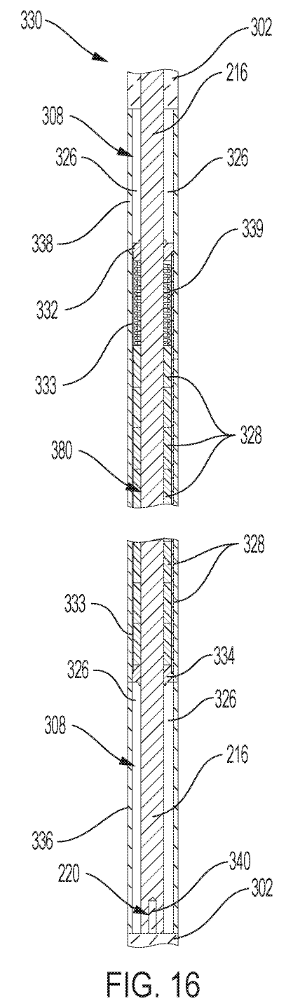

Similarly, the fuel rod 330 sits in the channel 308 of the nuclear micro-reactor core 300 and the fuel rod 330 extends through the core structure monolith 378. Each fuel heat pipe 216 extends through the entire channel 308 in the nuclear micro-reactor core 300 and it also extends through a channel 380 (FIG. 16) in the fuel rod 330. The channel 308 is similar to channel 310 and goes through the bottom reflector 336, the core structure monolith 378, the top reflector 338, and the top 304 of the container 302. When the heat exchanger 200 is placed against the top 304 of the nuclear micro-reactor core 300, the channel 224 in the heat exchanger 200 lines up with the channel 308 in the nuclear micro-reactor core 300. This allows the fuel heat pipe 216 to extend through the channel 308 in the nuclear micro-reactor core 300 and into the channel 224 in the heat exchanger 200. As can be seen in FIG. 14, the non-fuel heat pipes 218 extend into the heat exchanger 200 farther than the fuel heat pipes 216.

Similar to channels 308 and 310, the control rod channel 312 extends through the bottom reflector 336, the core structure monolith 378, the top reflector 338, and the top 304 of the container 302. When the heat exchanger 200 is placed against the top 304 of the nuclear micro-reactor core 300, the channel 110 in the heat exchanger 200 lines up with the channel 312 in the nuclear micro-reactor core 300. Each reactivity control rod 106 is configured to be dispositioned through one or more reactivity control cells 324 through the reactivity control rod channel 312. As previously discussed, each reactivity control rod 106 includes a neutron absorbing material configured to slow and/or stop the nuclear reactions within the nuclear micro-reactor core 300 in the case of an emergency. The reactivity control rods 106 collectively work to prevent the nuclear micro-reactor core 300 from achieving a critical temperature in the event of a reactor and/or power failure.

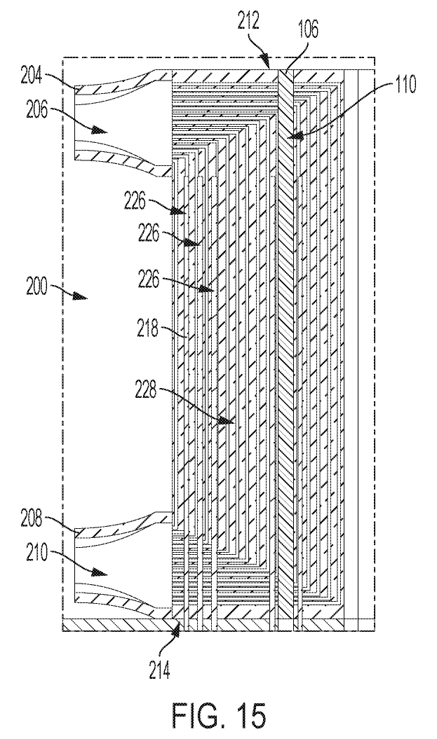

FIG. 15 shows a detailed view of the cross section of the heat exchanger 200 shown in FIG. 13, according to at least one aspect of the present disclosure. In various aspects, the top nozzle 204 is connected to the bottom nozzle 208 by micro-channels 228 that extend into the heat exchanger 200 between the nozzles 204, 208. The channels 110, 224, 226 in the heat exchanger 200 extend from the bottom 214 of the heat exchanger 200 toward the top 212 of the heat exchanger. The channel 110 extends the entire way from the bottom 214 to the top 212. In one aspect, the micro-channels 228 go around the larger channels 110, 224, 226 such that the micro-channels 228 form unbroken channels between the nozzles 204, 208. In an alternative aspect, the micro-channels 228 meet the larger channels 110, 224, 226. The micro-channels 228 allow the power conversion working fluid to flow through the nozzles 204, 208. In at least one aspect, the power conversion working fluid is air. In one aspect, the power conversion working fluid flows into the heat exchanger 200 at nozzles 208 and out through nozzles 204. In an alternative aspect, the power conversion working fluid flows into the heat exchanger 200 at nozzles 204 and out through nozzles 208.

FIG. 16 is a detailed view of the cross section of the annular fuel rod 330 shown in FIG. 14, according to at least one aspect of the present disclosure. The fuel heat pipe 216 defines a slot 220 that is inserted onto the rod 340 that extends from the bottom of the container 302. The fuel heat pipe 216 extends through the fuel rod 330 through channel 380 in the fuel rod 330. The fuel rod 330 has an external cladding 333 that extends from a bottom plug 334 to a top plug 332. The fuel is located inside the external cladding 333. In various aspects, the fuel is in the form of annular pellets 328. A spring 339 is used to compress the annular pellets 328. In some alternative aspects, the fuel could be in the form of solid pellets or rods, for example. In some aspects, the fuel rod 330 is configured to attach to the fuel heat pipe 216 to maintain the location of the fuel rod 330 above the bottom reflector 336 in the moderator monolith structure 378. In an alternative aspect, the channel 308 in the bottom reflector 336 is a smaller diameter such that the fuel rod 330 would sit on top of the bottom reflector 336. The smaller diameter could be chosen to still allow the heat pipe 216 to extend through the bottom reflector 336. As shown in FIG. 16, the fuel rod 330 and the fuel heat pipe 216 extend through the channel 308.

Referring to FIGS. 13-16, it can be apparent to the reader that removal of the heat exchanger 200 can enable an operator to access the fuel rods 330, the fuel heat pipes 216, and the non-fuel heat pipes 218 for inspection, replacement, or repair. This is enabled by the ability of the fuel rods 330, fuel heat pipes 216, and non-fuel heat pipes 218 to slide into the nuclear micro-reactor core 300 through the channels 308, 310.

The nuclear micro-reactor 100 can be configured to accommodate moderators in the nuclear micro-reactor core 300. An example monolith structure 382 adding moderators to the nuclear micro-reactor core 300 is shown in FIGS. 17-26. The nuclear micro-reactor core 300 functions in a substantially similar manner with either the monolith structure 378 shown in FIG. 7 or the monolith structure 382 shown in FIG. 17. There are differences between the monolith structures 378, 382. The monolith structure 382 shown in FIG. 17 is an example of how to add the moderator rods 352 to the nuclear micro-reactor core 300. The moderator rods 352 could be added to the nuclear micro-reactor core 300 in a variety of different ways. For example, some of the fuel rods 330 could simply be replaced with moderator rods. For the sake of brevity, not all similarities between the two monolith structures 378, 382 of the nuclear micro-reactor core 300 will be described in detail.

FIG. 17 is a cross-sectional view of a nuclear micro-reactor core 300 configuration, according to at least one aspect of the present disclosure. Referring to FIG. 17, similar to the first monolith structure 378, the second monolith structure 382 of the nuclear micro-reactor core 300 includes a plurality of fuel unit cells 342, 344, 346, 348, and reactivity control unit cells 350. Additionally, the second monolith structure 382 is surrounded by reflectors 316. The fuel unit cells 342, 344, 346, 348 are configured to accommodate fuel and non-fuel heat pipes 216, 218 and fuel in any suitable configuration (e.g., stacks and/or rods), which can collectively generate nuclear power and manage thermal energy throughout the nuclear micro-reactor core 300. The reactivity control cells 350 are configured to accommodate the fuel and non-fuel heat pipes 216, 218, fuel, and the reactivity control rods 106.

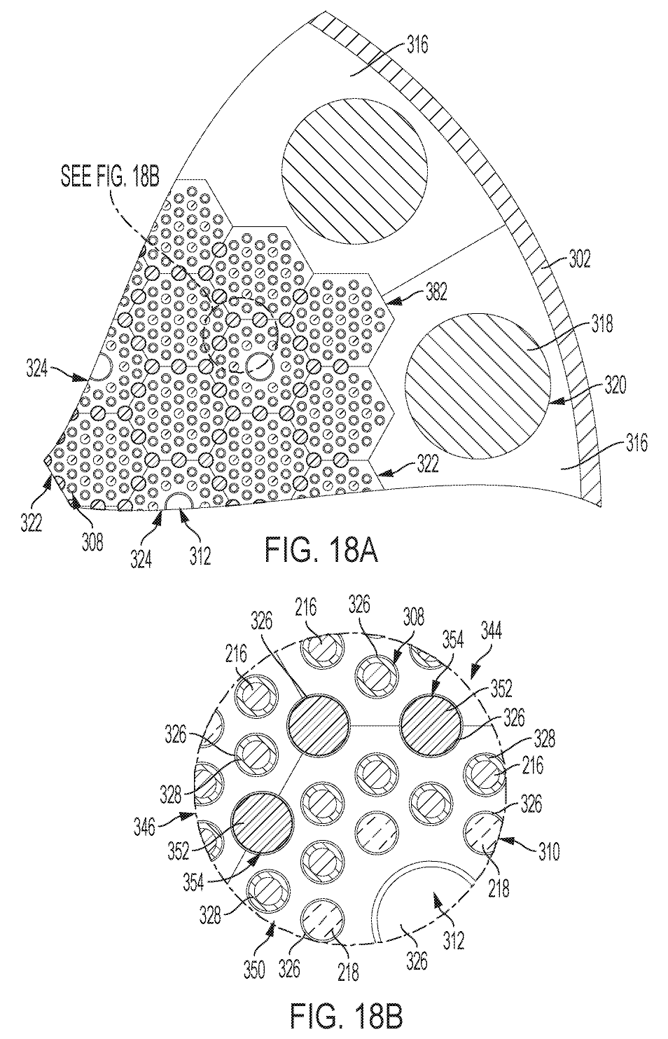

FIG. 18A is a detailed view of the monolith structure 382 and FIG. 18B is the detailed view of the monolith structure 382 shown in FIG. 18A, according to at least one aspect of the present disclosure. With reference to FIGS. 17, 18A, and 18B, the moderator rod channels 354 are formed between the fuel unit cells 342, 344, 346, 348 and/or the reactivity control unit cells 350. The moderator rods 352 are inserted into the moderator channels 354. For the fuel rods 330 and non-fuel heat pipes 218, the monolith structure 382 shown in FIG. 17 is similar to the monolith structure 378 shown in FIG. 7. The fuel rods 330 are inserted into the channels 308 in the monolith structure 382 and the non-fuel heat pipes 218 are inserted into channels 310 in the monolith structure 382. Each fuel heat pipe 216 is inserted into a channel 380 extending through a fuel rod 330. The detailed view of FIG. 18B shows pellets 328 surrounding fuel heat pipes 216 both inserted into the channels 308.

A thermal bond material 326 surrounds everything in the container 302. For example, the thermal bond material 326 is found between the fuel heat pipes 216 and the fuel rods 330 as well as surrounding the non-fuel heat pipes 218 in channels 310. The thermal bond material 326 is also found between the fuel unit cells 342, 344, 346, and 348 and/or the control rod unit cells unit cells 350. This includes the thermal bond material 326 surrounding the moderator rods 352 in the moderator rod channels 354. Similar to monolith structure 378, the control rod channels 312 allow the control rods 106 to be inserted into the monolith structure 382. When a reactivity control rod 106 (FIG. 2) is inserted into a control rod channel 312, the thermal bond material 326 is displaced to allow the reactivity control rod 106 to enter the channel. Once the reactivity control rod 106 is inserted into the control rod channel 312, the thermal bond material 326 surrounds the reactivity control rod 106.

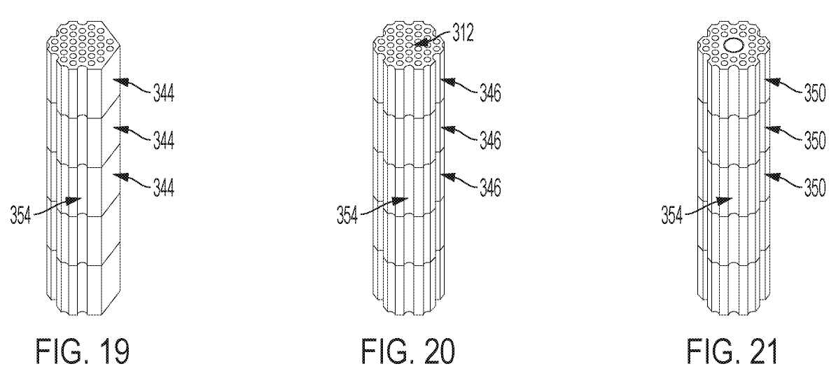

FIGS. 19-21 are perspective views of fuel unit cells 344, 346 and control rod unit cell 350 of the nuclear micro-reactor core 300 configuration shown in FIG. 17, according to at least one aspect of the present disclosure. Referring to FIGS. 19-21, similar to the fuel unit cells 322 and control rod unit cells 324 shown in FIG. 7, the fuel unit cells 342, 344, 346, 348 and the control rod unit cells 350 shown in FIG. 17 are configured to span at least a portion of the length L of the nuclear micro-reactor core 300. FIG. 19 shows a stack of fuel unit cells 342 and FIG. 20 shows a stack of fuel unit cells 346. As shown in FIGS. 17-20, the difference between the fuel unit cells 342, 344, 346, 348 is the number of moderator rod channels 354. Stated another way, the moderator rod channels 354 are placed on the sides of fuel unit cells 342, 344, 346, 348 and the number of moderator rod channels 354 is the difference between the fuel unit cells 342, 344, 346, 348. For example, the fuel unit cell 342 has 5 moderator rod channels 354, the fuel unit cell 344 has 7 moderator rod channels 354, the fuel unit cell 346 has 12 moderator rod channels 354, and the fuel unit cell 348 has 9 moderator rod channels 354. The control rod unit cell 350, shown in FIG. 21, has 12 moderator rod channels 354. The moderator rod channels 354 in the fuel unit cells 342, 344, 346, 348 and control rod unit cells 350 form a circular channel when the moderator monolith 382 is constructed by placing the unit cells 342, 344, 346, 348, 350 together. However, in various alternative aspects, the moderator rod channel 354 could have any geometry or means that allows a moderator rod to be inserted into the channel.

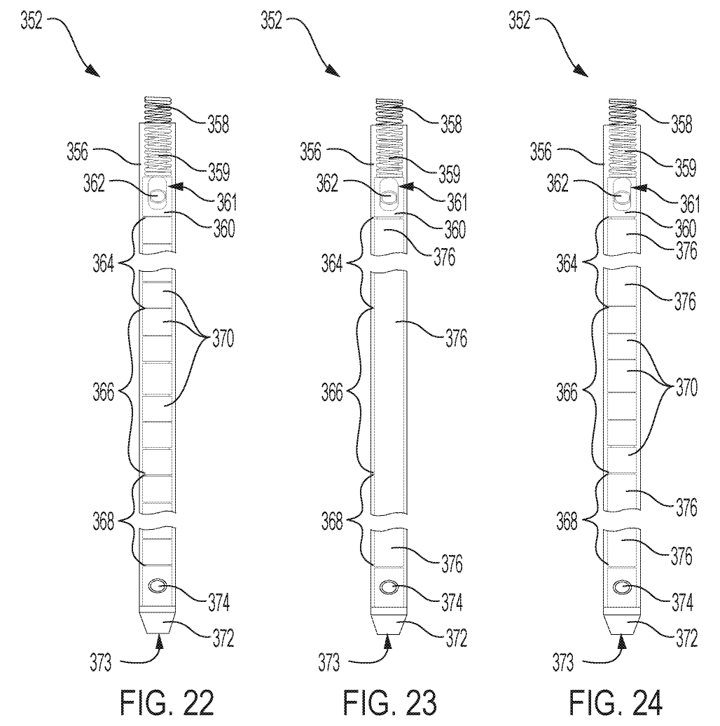

FIGS. 22-24 show 3 different examples of moderator rods 352. FIG. 22 is a side view of the moderator rod 352 with the outer shell being transparent, FIG. 23 is a side view of the moderator rod 352 with the outer shell being transparent, and FIG. 24 is a side view of the moderator rod 352 with the outer shell being transparent, according to at least one aspect of the present disclosure. The difference between the moderator rods 352 shown in FIGS. 22-24 is what is located inside an external cladding 356. The moderator rods 352 have a bottom plug 372 that is inserted into the external cladding 356. In some aspects, a rod 374 is inserted through the external cladding 356 and a bottom plug 372 to lock the bottom plug 372 in place. The bottom end plug 372 defines a slot 373 that extends into the bottom end plug 372. The external cladding 356 extends distally away from the bottom plug 372 until it reaches a top plug 360. The top plug 360 is inserted into the distal end of the external cladding 356. In some aspects, a rod 362 is inserted through a channel 361 in the external cladding 356 and a hole in the top plug 360. This allows the top plug 360 to slide relative to the external cladding 356 for the length of the channel 361. The top plug 360 has a rod 359 extending distally from the top plug 360. A spring 358 is placed into the external cladding 356 and on the rod 359 such that the spring 358 extends distally away from the top plug 360 and outside of the external cladding 356.

The distance between the bottom plug 372 and the top plug 360 can be broken into 3 sections, for example, a bottom stack 368, a middle stack 366, and a top stack 364. In various alternative aspects, the distance can be broken into any number of sections. The type of material inserted into the external cladding 356 of the moderator rod 352 between the top plug 360 and the bottom plug 372 may vary. For example, the material type could vary based on the section the material is located in. Some potential material types inserted into the moderator rods 352 could be pellets, reflector, and/or shielding. FIG. 22 shows the bottom section 368, the middle section 366, and the top section 364 all containing pellets 370. FIG. 23 shows the bottom section 368, the middle section 366, and the top section 364 all containing moderator 376. FIG. 24 shows the bottom section 368 and the top section 364 containing the moderator 376 and the middle section 366 containing pellets. There are numerous combinations that could be made from including pellets, reflector, and shielding in the moderator rods 352. For the sake of brevity, not all of the combinations are shown. However, the reader can readily appreciate that any section of the moderator 376 shown in FIGS. 23 or 24 could be switched with shielding or pellets.

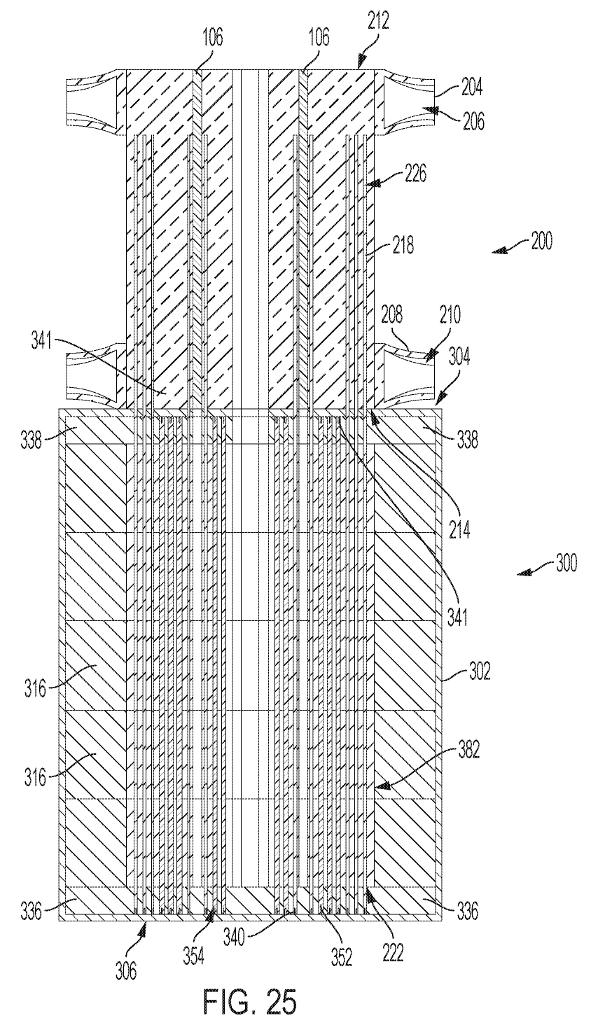

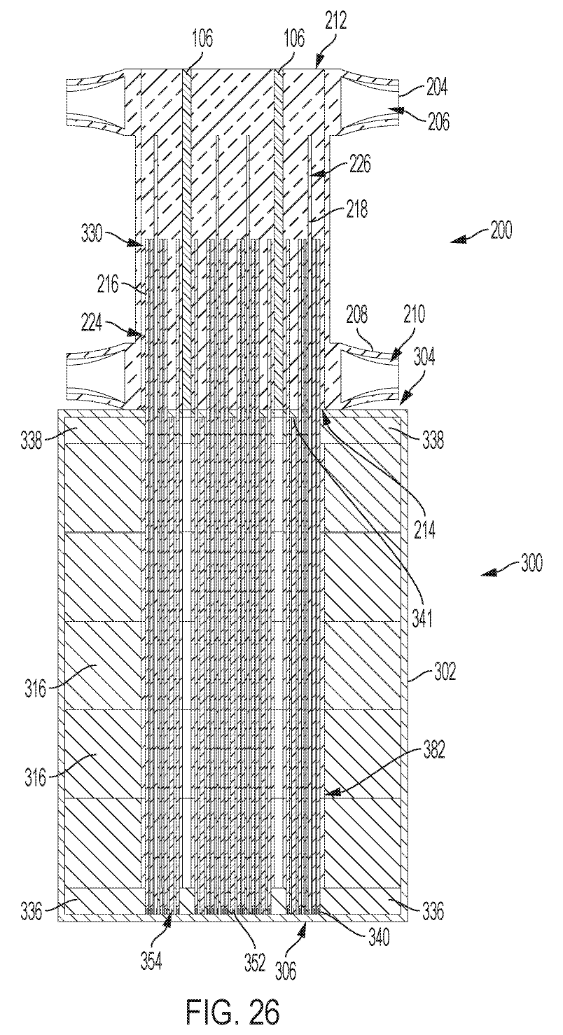

FIG. 25 is a cross-sectional view of the entire nuclear micro-reactor 100 taken along section line 25—25 shown in FIG. 17 and FIG. 26 is a cross-sectional view of the entire nuclear micro-reactor 100 taken along section line 26—26 shown in FIG. 17, according to at least one aspect of the present disclosure. Referring to FIGS. 25 and 26, the rods 340 extend into the container 302 from the bottom 306 of the container 302. Each one of the non-fuel heat pipes 218 defines a slot 222 that matingly couples with one of the rods 340, each fuel heat pipe 216 defines a slot 220 that matingly couples with one of the rods 340, and each moderator rod bottom plug 372 defines a slot 373 that matingly couples with one of the rods 340. The rods 340 help hold the fuel heat pipes 216, the non-fuel heat pipes 218, and the moderator rods 352 in place. The fuel heat pipes 216, the non-fuel heat pipes 218, and the moderator rods 352 extend through the bottom reflector 336, the core structure monolith 382 and the top reflector 338. The fuel heat pipes 216 and the non-fuel heat pipes 218 extend through the top 304 of the container 302 into the heat exchanger 200. The moderator rod 352 is placed in the nuclear micro-reactor core 300 such that the spring 358 is placed on a rod 341 extending from the top 304 and into the container 302. The spring 358 applies a compressive force to the material inside of the moderator rod 352. Each one of the moderator rods 352 extends through a channel 354 defined in the nuclear micro-reactor core 300, each one of the non-fuel heat pipe 218 extends through a channel 310 defined in the nuclear micro-reactor core 300, and each one of the fuel rods 330, and each one of the heat pipe 216 extend through a channel 308 in the nuclear micro-reactor core 300.

### Alternative Configurations

Two configurations have been described in detail. However, there are numerous different configurations that can be used for nuclear micro-reactor 100. Some of the different configurations will be described below.

An alternative configuration of the nuclear micro-reactor 100 utilizes fuel in an annular fuel/heat pipe configuration with a heat pipe as the inner diameter of an annular fuel rod and potentially, additional solid fuel rods. In this configuration, the thermal bonding material 326 is a gas that would replace the liquid. Candidate gases include but are not limited to carbon dioxide or helium. The purpose of the gas is twofold: first to exclude oxygen that could oxidize the graphite moderator and, secondly, to provide thermal bonding between the various reactor components. The use of gas thermal bonding allows the reactor to be oriented horizontally which, in turn, enables the use of dual condenser heat pipes that enable practical heat removal from two sides of the reactor instead of just one, as is required with liquid thermal bonding. For example, a heat exchanger 200 could be placed against both the bottom surface 306 and the top surface 304 if the heat exchanger is oriented horizontally. In one aspect, the annular fuel pellet is thermally bonded to the inner and outer tubes with a pressurized helium backfill. This could result in higher fuel temperatures than liquid bonded fuel but the low thermal power density of a heat pipe reactor makes the higher fuel temperatures acceptable. In some aspects, pressurized operation of the micro-reactor would be required to maximize heat transfer from the fuel to the heat pipes. The outer diameter of the annular fuel/heat pipe combination transfers heat through the gas gap to the graphite and metal hydride solid moderators as well as additional non-fuel heat pipes. Alternate configurations using separate fuel rods without annular fuel and heat pipes are also applicable. In this aspect, gas thermal bonding is effective due to the low thermal power density typical of heat pipe reactors.

Yet another configuration is one using solid fuel rods, heat pipes, and optional solid moderator rods in addition to or excluding annular fuel elements in a graphite reactor structure in which the aforementioned reactor components are thermally bonded to each other by either a liquid thermal bonding material as described above or a gas thermal bonding material also as described above. This aspect simplifies the primary heat exchanger configuration at the expense of the higher efficiency heat transfer if annular fuel elements are eliminated. Alternatively, adding solid fuel elements in addition to annular fuel elements will increase low temperature heat transfer power split to the graphite moderator. For example, solid fuel elements could be added similar to how the moderator rods were added to moderator monolith 382. Additionally or alternatively, some of the annular fuel rods could be replaced with solid fuel rods, which would require those fuel rod channels to be the same as a moderator channel. Accordingly, those fuel rod channels would not have a fuel heat-pipe 216 that exits the nuclear micro-reactor core 300. Increasing the low temperature constant power heat transfer split enables optimization of low temperature heat transfer from the annular and the solid fuel rod outer diameters, with a high temperature heat transfer from the annular fuel rod inner diameter, to optimize fuel rod heat transfer and primary heat exchanger performance.

An alternative configuration of a heat pipe also envisioned, where the heat-pipe is that of a thermosiphon device, again typically using Na or NaK as the working fluid, but now at or slightly above atmospheric pressure in a molten column. Because this configuration requires a vertical orientation to enable the thermosiphon effect, it is most advantageous to liquid thermal bonding techniques. The difference between these configurations is in the mass transport mechanism within the heat pipe being primarily as vapor convection in the case of the classic heat pipe, e.g., fuel and non-fuel heat pipes 216, 218, and as primarily liquid convection with vapor supplementation in the case of the thermosiphon. In some aspects, the thermosiphon will be less susceptible to failure due to the much larger inventory of working fluid, and thereby lower sensitivity to contamination.

### Stability

The reactor physics are designed to be autonomous and inherently self-limiting in both maximum power output and maximum operating temperature through a unique combination of Doppler feedback, a combination of graphite reactor structure, and optional metal hydride moderators that work together to limit the maximum steady-state operating temperature versus reactor power level. The presence of a substantial amount of 238U or 232Th assures that there is always a significant and prompt negative thermal feedback from Doppler broadening in these fertile resonance absorbers to limit any short term (< 1 to ~60 seconds) reactivity imbalance to maintain safe and inherently limited operation. This prompt negative fuel temperature reactivity feedback provides an inherent limitation upon the peak power that is achievable in the extremely unlikely event of a rapid reactivity insertion from the reactivity control or power conversion system.

Medium term (minutes to days) reactivity balance and the resulting steady state reactor power and upper steady state operating temperature is limited by controlling the proportion of moderation from graphite versus that provided by the optional solid metal hydride moderators, ensuring that the reactor is substantially under-moderated without the additional effective moderation from the solid metal hydride moderators. The graphite reactor structure provides the bulk of the moderation to enable criticality. However, the proportion of graphite to metal hydride moderators is determined such that the reactor is near-optimally moderated at temperatures up to operating conditions, but that there is always insufficient core reactivity due to the non-linear reactivity feedback of the metal hydride moderators, including failure of the reactivity control system to actuate, to sustain additional nuclear heat above temperatures at which the reactor materials of construction are qualified. This means of reactivity control enables a limitation on the reactivity control system such that the worst case malfunction of this control system is safely compensated by the inherent negative Doppler and solid moderator power/temperature feedback.

Long term steady state reactivity control is obtained through the judicious use of burnable absorbers to limit the available excess reactivity throughout the operating lifetime. Limiting available excess core reactivity, aside from being generally good engineering practice, has the salutary effect of limiting the reactor heat up that would occur under a loss of heat sink. This ensures that the reactor materials remain within their qualified service temperature range without credit for a reactor control action and the pressure within the solid moderator elements remains below that which could result in cladding failure. This enables the reactor to safely withstand any loss of heat sink event on an indefinite basis while the passive shutdown heat removal system provides decay heat removal.

Finally, the reactivity control system provides negative reactivity to enable cool down of the reactor to ambient temperatures and reactivity trim to optimize reactor operating temperature versus power output and lifetime. The reactivity control system utilizes strong absorbers which are inserted into the core and/or reflector region of the reactor. These absorbers provide the diverse reactivity control necessary to cause safe reactor shutdown at ambient conditions throughout core lifetime. The maximum available reactivity worth of the reactivity control system are designed such that no fault of the reactivity control system is capable of providing a positive reactivity that would challenge fuel safety limits or enable the reactor to exceed the safe maximum operating temperature.

### Transportation

The reactivity control system is used as an essential part of the safe transport of the reactor with liquid metal/molten salt thermal bonding from the point of manufacture to the destination site. The reactor is assembled in the manufacturing environment so that criticality is strictly avoided by always having full and mechanically locked insertion of the control elements into the reactor region when fuel is also loaded in the reactor. Locking the control elements into the reactor is sufficient to preclude criticality in the extremely unlikely event that the reactor is fully fueled and the two most reactive control elements (N-2 criteria) become unlocked and fully withdrawn. One of the final steps in the reactor manufacture involves filling the assembled reactor with a liquid thermal bond material and allowing the liquid to solidify, or freeze, thereby locking the reactor in a known safe shutdown state for transport and until the reactor is safely installed at its final location.

Shipping the reactor frozen in its operating liquid thermal bonding material is a substantial and passive Item Relied On For Safety (IROFS) because it provides the following safety-related functions during transport. First, it precludes movement of control elements from their position within the reactor and or reflector, guaranteeing that the reactor is always subcritical by a substantial safety margin. Second, it precludes flooding of the reactor with water to increase moderation and reactivity. Third, it enables manufacturing the finished reactor in a factory setting with the associated quality and productivity benefits to rapidly achieve lower costs and faster delivery schedules. Fourth, it distributes normal transport accelerations across the entire reactor structure instead of allowing stress concentrations to damage delicate fuel structures with localized loads caused by gaps and accelerations across the gap elements. Fifth, it renders the fuel material essentially immune to diversion, due to the high weight of the frozen reactor and the time and energy requirements necessary to melt away the liquid from the reactor. Sixth, it protects the environment from any potential for dispersal in the event of credible transportation impact loads. Finally, seventh, it provides shielding of the fuel material to the environment enabling the use of recycled fuel material.

Alternatively, the gas thermal bonded configurations also rely upon the reactivity control system as an essential part of the safe transport of the reactor from the point of manufacture to the destination site. The reactor is assembled in the manufacturing environment so that criticality is strictly avoided by always having full and mechanically locked insertion of the control elements into the reactor region when fuel is also loaded in the reactor. Locking the control elements into the reactor is sufficient to preclude criticality in the extremely unlikely event that the reactor is fully fueled and the two most reactive control elements become unlocked and fully withdrawn. Shipping the reactor with its control elements mechanically locked in the fully inserted position is a substantial Item Relied On For Safety (IROFS) because it provides the following safety-related functions during transport. First, it precludes movement of control elements from their position within the reactor and or reflector, guaranteeing that the reactor is always subcritical by a substantial safety margin. Second, it enables manufacturing the finished reactor in a factory setting with the associated quality and productivity benefits to rapidly achieve lower costs and faster delivery schedules. Finally, third, it minimizes the weight of the reactor for transport.

### Advantages

There are a multitude of advantages of the nuclear micro-reactor 100. For example, the annular fuel rod transfers heat to the thermal bond material at a low temperature from the fuel outer diameter and a high temperature from the fuel ID, and the temperature difference increases the source temperature and the power conversion cycle efficiency. Additionally, the nuclear micro-reactor 100 has the flexibility to utilize non-annular clad fuel rods to increase fuel loading and heat transfer directly to the thermal bond material. The fuel rod thermal bonding to both solid and annular fuel pellets with liquid thermal bond material can minimize fuel pellet thermal stresses and fission gas release.

The nuclear micro-reactor 100 has a non-structural, low-parasitic graphite moderator monolith to provide reactor component lattice spacing and natural circulation coolant channels which reduce the reactor fissile loading requirements and enable thermal bonding of all reactor components. All reactor components are radially floating within the graphite moderator structure and can be thermally bonded to a pool of liquid thermal bond material to eliminate gas gap heat transfer in favor of liquid heat conduction. The liquid thermal bonding provides a number of benefits including, but not limited to minimizing thermal stresses, ensuring adequate cooling of fuel even in the event of multiple heat pipe failure, increasing reactor thermal inertia, thereby slowing the power/temperature reactor transient response to anticipated operational occurrences, eliminating any concern of graphite moderator combustion or damage from Wigner energy release, providing a low cost, highly-effective reactor vessel and biological shield, enabling transport of the reactor with control elements frozen in the shutdown positions, and flooding is precluded by displacement of any reactor void volume with frozen liquid thermal bonding material.

Alternatively, a gas thermal bonding material can be utilized with free floating reactor components within a graphite moderator monolith structure. The use of gas thermal bonding enables horizontal orientation which then enables the use of dual condenser heat pipes with dual primary heat exchangers to maximize power output. The use of a gas thermal bonding material requires operation above atmospheric pressure to obtain acceptable heat transfer which thereby requires compensatory actions in the event of loss of coolant due to leakage or thermal diffusion to maintain acceptable shutdown heat transfer and inert atmosphere to preclude oxidation of the graphite moderator monolith.

The Emergency Planning Zone of the nuclear micro-reactor 100 is no larger than the site boundary due to using a high-A liquid thermal bond material such as lead, which is an effective mechanism to limit radioactive release in the extremely unlikely event of fuel failure. Additionally, there is an integral reflector and vessel shield contained within reactor vessel and thermally bonded to the reactor thermal bond material. A guard vessel can preclude loss of liquid thermal bonding. The guard vessel is designed to assure that the fuel will remain covered by the thermal bond material even in the beyond design basis vessel failure event. If needed, the nuclear reactor 100 can be designed so that the passive air shutdown cooling is augmented by water heat transfer of the guard vessel for shutdown decay heat removal.

The nuclear micro-reactor 100 can passively limit the maximum reactor temperature through the utilization of optional metal hydride solid moderator negative reactivity feedback. Also the reactor safety instrumentation is limited to reactor thermal bond material maximum temperature and nuclear flux monitoring. There is no need for in-core instrumentation of nuclear or heat transfer parameters required. This allows for autonomous operation by maintaining constant high-temperature criticality. Operator interaction is only required to approach criticality due to strong negative feedback from metal hydride solid moderator.

Heat pipe thermal/mechanical connections made to the primary heat exchanger, enable access to reactor by lifting the primary heat exchanger with the heat pipe extensions from the bottom of the primary heat exchanger out of reactor region. This will allow repair and refueling of the reactor, and replacement of the primary heat exchanger and heat pipes. The heat pipe thermal connections to the primary heat exchanger are augmented by the use of bi-metallic, differential thermal expansion of the heat pipe (e.g., steel/copper) into the primary heat exchanger. This takes advantage of the higher temperature of the heat pipe to create a tight thermal and mechanical connection to the primary heat exchanger.

The nuclear micro-reactor 100 can use metal hydrides for supplemental moderation and additional negative reactivity feedback that uses the negative reactivity feedback that results from high temperature moderation degradation of metal hydrides.

The nuclear micro-reactor core 300 has lattice positions for non-fueled heat pipes to transfer nuclear and shutdown heat. It also has lattice positions for fuel rods. In some aspects, the fuel rods have annular pellet fuel rod components. Additionally or alternatively, the fuel rods can have solid pellet fuel rod components. The micro-reactor can accommodate burnable absorber use in both solid and annular fuel elements. Both the non-fuel heat pipes and the fuel heat pipes can accommodate the use of both alkali metal phase change and thermosiphon heat pipes for passive nuclear heat transport from the reactor fuel to the primary heat exchanger. The micro-reactor also has lattice positions for control elements for reactor shutdown and fine power/temperature control.

### EXAMPLES

Various aspects of the subject matter described herein are set out in the following numbered examples.

Example 1 - A passively cooled nuclear reactor, comprising a heat exchanger and a nuclear reactor core disposed proximal to the heat exchanger. The nuclear reactor core comprising a fuel rod, a heat pipe located proximate to the fuel rod and extending from the nuclear reactor core into the heat exchanger, a moderator monolith configured to house and space the fuel rod and the heat pipe, and a thermal bond material disposed internally throughout the moderator monolith to surround the fuel rod and the heat pipe with the thermal bond material and to facilitate heat transfer from the nuclear reactor core to the heat exchanger.

Example 2 - The nuclear reactor of Example 1, wherein the moderator monolith further defines a plurality of apertures, wherein the fuel rod is configured to be slidably disposed through a first aperture defined by the moderator monolith, and wherein the heat pipe is configured to be slidably disposed through a second aperture defined by the moderator monolith.

Example 3 - The nuclear reactor of Examples 1 or 2, wherein the nuclear reactor core further comprises a moderator rod configured to be slidably disposed through a third aperture defined by the moderator monolith.

Example 4 - The nuclear reactor of Examples 1, 2, or 3, wherein the nuclear reactor core is in contact with the heat exchanger through the heat pipe.

Example 5 - The nuclear reactor of Examples 1, 2, 3, or 4, wherein the thermal bond material comprises a two state material.

Example 6 - The nuclear reactor of Examples 1, 2, 3, 4, or 5, wherein in a first state of the nuclear reactor the thermal bond material is in a solid state to lock the fuel rod and heat pipe in place, and in a second state of the nuclear reactor, the thermal bond material is in a liquid state.

Example 7 - The nuclear reactor of Example 5, wherein the two state material is lead.

Example 8 - The nuclear reactor of Examples 1, 2, 3, or 4, wherein the thermal bond material is a gas.

Example 9 - The nuclear reactor of Examples 1, 2, 3, 4, 5, 6, 7, or 8, wherein the moderator monolith comprises a unit cell.

Example 10 - The nuclear reactor of Examples 1, 2, 3, 4, 5, 6, 7, 8, or 9, wherein the fuel rod is an annular fuel rod defining an aperture, wherein the heat pipe is a first heat pipe, and wherein the nuclear reactor core further comprises a second heat pipe configured to be slidably disposed through the aperture defined by the annular fuel rod.

Example 11 - The nuclear reactor of Example 10, wherein the first heat pipe extends into the heat exchanger farther than the second heat pipe.

Example 12 - The nuclear reactor of Examples 1, 2, 3, 4, 5, 6, 7, 8, 9, 10, or 11, wherein the nuclear reactor is configured to operate at atmospheric pressure in a range from 30 kPA to 103 kPa.

Example 13 - The nuclear reactor of Examples 1, 2, 3, 4, 5, 6, 7, 8, 9, 10, 11, or 12, further comprising a control rod drive mechanism disposed distal to the heat exchanger, wherein the control rod drive mechanism is configured to drive a control rod through the heat exchanger to the nuclear reactor core.

Example 14 - A passively cooled nuclear reactor comprising a heat exchanger and a nuclear reactor core disposed proximal to the heat exchanger. The nuclear reactor core comprising a plurality of fuel rods, a plurality of heat pipes extending from the nuclear reactor core into the heat exchanger, a moderator monolith comprising a plurality of apertures. Each one of the plurality of fuel rods is configured to be slidably disposed through a first set of apertures defined by the moderator monolith, wherein each one of the plurality of heat pipes is configured to be slidably disposed through a second set of apertures defined by the moderator monolith. The nuclear reactor core further comprises a reflector surrounding the moderator monolith and a thermal bond material disposed internally throughout the moderator monolith to surround the plurality of fuel rods and the plurality of heat pipes with the thermal bond material and facilitate heat transfer from the nuclear reactor core to the heat exchanger. The nuclear reactor core further comprises a container surrounding the reflector. The passively cooled nuclear reactor further comprises a plurality of control rod drive mechanisms disposed distal to the heat exchanger, wherein each control rod drive mechanism is configured to drive a control rod through the heat exchanger to the nuclear reactor core, and wherein the moderator monolith.

Example 15 - The nuclear reactor of Example 14, wherein the nuclear reactor core further comprises a plurality of moderator rods configured to be slidably disposed through a third set of apertures in the moderator monolith.

Example 16 - The nuclear reactor of Examples 14 or 15, wherein the thermal bond material is a two state material.

Example 17 - The nuclear reactor of Examples 14, 15, or 16, wherein in a first state of the nuclear reactor the thermal bond material is in a solid state to lock the plurality of fuel rods and the plurality of heat pipes in place, and in a second state of the nuclear reactor, the thermal bond material is in a liquid state.

Example 18 - The nuclear reactor of Examples 14, 15, 16, or 17, wherein the plurality of fuel rods are annular fuel rods, wherein the plurality of heat pipes are a first plurality of heat pipes, and wherein the nuclear reactor core further comprises a second plurality of heat pipes, wherein each heat pipe of the second plurality of heat pipes is configured to be slidably disposed through an aperture defined by each annular fuel rod of the plurality of fuel rods.

Example 19 - The nuclear reactor of Example 18, wherein the first plurality of heat pipes extend into the heat exchanger farther than the second plurality of heat pipes.

Example 20 - The nuclear reactor of Examples 14, 15, 16, 17, 18, or 19, wherein the reflector comprises a plurality of control drums.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

Various aspects of a solid-state fluid thermal bonded heat pipe micro-reactor have been described with reference to various exemplary and illustrative aspects. The aspects described herein are understood as providing illustrative features of varying detail of various aspects of the present disclosure; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the present disclosure. Accordingly, it will be recognized by persons having ordinary skill in the art that various substitutions, modifications or combinations of any of the exemplary aspects may be made without departing from the scope of the present disclosure. In addition, persons skilled in the art will recognize, or be able to ascertain using no more than routine experimentation, many equivalents to the various aspects of the present disclosure described herein upon review of this specification. Thus, the present disclosure is not limited by the description of the various aspects, but rather by the claims.

Those skilled in the art will recognize that, in general, terms used herein, and especially in the appended claims (e.g., bodies of the appended claims) are generally intended as "open" terms (e.g., the term "including" should be interpreted as "including but not limited to," the term "having" should be interpreted as "having at least," the term "includes" should be interpreted as "includes but is not limited to," etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to claims containing only one such recitation, even when the same claim includes the introductory phrases "one or more" or "at least one" and indefinite articles such as "a" or "an" (e.g. ,"a" and/or "an" should typically be interpreted to mean "at least one" or "one or more"); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of "two recitations," without other modifiers, typically means at least two recitations, or two or more recitations). Furthermore, in those aspects where a convention analogous to "at least one of A, B, and C, etc." is used, in general such a construction is intended in the sense one having skill in the art would understand the convention (e.g., "a system having at least one of A, B, and C" would include but not be limited to systems that have A alone, B alone, C alone, A and B together, A and C together, B and C together, and/or A, B, and C together, etc.). In those aspects where a convention analogous to "at least one of A, B, or C, etc." is used, in general such a construction is intended in the sense one having skill in the art would understand the convention (e.g., "a system having at least one of A, B, or C" would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase "A or B" will be typically understood to include the possibilities of "A" or "B" or "A and B."

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like "responsive to," "related to," or other past-tense adjectives are generally not intended to exclude such variants, unless context dictates otherwise.

It is worthy to note that any reference to "one aspect," "an aspect," "one aspect," "an aspect," "an exemplification," "one exemplification," and the like means that a particular feature, structure, or characteristic described in connection with the aspect is included in at least one aspect. Thus, appearances of the phrases "in one aspect," "in an aspect," "in an exemplification," and "in one exemplification" in various places throughout the specification are not necessarily all referring to the same aspect. Furthermore, the particular features, structures or characteristics may be combined in any suitable manner in one or more aspects.

As used herein, the singular form of "a", "an", and "the" include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms "about" or "approximately" as used in the present disclosure, unless otherwise specified, means an acceptable error for a particular value as determined by one of ordinary skill in the art, which depends in part on how the value is measured or determined. In certain aspects, the term "about" or "approximately" means within 1, 2, 3, or 4 standard deviations. In certain aspects, the term "about" or "approximately" means within 50%, 200%, 105%, 100%, 9%, 8%, 7%, 6%, 5%, 4%, 3%, 2%, 1 %, 0.5%, or 0.05% of a given value or range.

In this specification, unless otherwise indicated, all numerical parameters are to be understood as being prefaced and modified in all aspects by the term "about," in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of "1 to 100" includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of "1 to 100" includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms "comprise" (and any form of comprise, such as "comprises" and "comprising"), "have" (and any form of have, such as "has" and "having"), "include" (and any form of include, such as "includes" and "including") and "contain" (and any form of contain, such as "contains" and "containing") are open-ended linking verbs. As a result, a system that "comprises," "has," "includes" or "contains" one or more elements possesses those one or more elements, but is not limited to possessing only those one or more elements. Likewise, an element of a system, device, or apparatus that "comprises," "has," "includes" or "contains" one or more features possesses those one or more features, but is not limited to possessing only those one or more features.

Whereas particular examples of the present disclosure have been described above for purposes of illustration, it will be evident to those skilled in the art that numerous variations of the details of the present disclosure may be made without departing from the present disclosure as defined in the appended claims.

What is claimed is:

1. A passively cooled nuclear reactor, comprising:
a heat exchanger; and
a nuclear reactor core disposed proximal to the heat exchanger, the nuclear reactor core comprising:
a fuel rod;
a first heat pipe extending from the nuclear reactor core into the heat exchanger;
a moderator monolith configured to house and space the fuel rod and the first heat pipe; and
a heat transfer material comprising disposed internally throughout the moderator monolith to surround the fuel rod and the first heat pipe with the heat transfer material;
wherein the fuel rod is an annular fuel rod defining an aperture, and wherein the nuclear reactor core further comprises a second heat pipe, wherein the second heat pipe extends into the aperture, wherein the second heat pipe extends into the heat exchanger, wherein the first heat pipe extends into the heat exchanger farther than the second heat pipe.

2. The nuclear reactor of claim 1, wherein the moderator monolith further defines a plurality of apertures, wherein the fuel rod is configured to be slidably disposed through a first aperture defined by the moderator monolith, and wherein the first heat pipe is configured to be slidably disposed through a second aperture defined by the moderator monolith.

3. The nuclear reactor of claim 1, wherein the nuclear reactor core further comprises a moderator rod configured to be slidably disposed through a third aperture defined by the moderator monolith.

4. The nuclear reactor of claim 1, wherein the nuclear reactor core is in contact with the heat exchanger through the first heat pipe.

5. The nuclear reactor of claim 1, wherein the heat transfer material comprises a two state material.

6. The nuclear reactor of claim 5, wherein in a first state of the nuclear reactor the heat transfer material is in a solid state to lock the fuel rod and heat pipe in place, and in a second state of the nuclear reactor, the heat transfer material is in a liquid state.

7. The nuclear reactor of claim 5, wherein the two state material is lead.

8. The nuclear reactor of claim 1, wherein the moderator monolith comprises a unit cell.

9. The nuclear reactor of claim 1, further comprising:
a control rod drive mechanism disposed distal to the heat exchanger, wherein the control rod drive mechanism is configured to drive a control rod through the heat exchanger to the nuclear reactor core.

10. The nuclear reactor of claim 1, wherein the heat exchanger is a first heat exchanger, and wherein the nuclear reactor further comprises a second heat exchanger disposed proximal to the nuclear reactor core and distally from the first heat exchanger.

11. A passively cooled nuclear reactor, comprising:
a heat exchanger;
a nuclear reactor core disposed proximal to the heat exchanger, the nuclear reactor core comprising:
a plurality of fuel rods;
a plurality of first heat pipes extending from the nuclear reactor core into the heat exchanger;
a moderator monolith comprising a plurality of apertures,
wherein each one of the plurality of fuel rods is configured to be slidably disposed through a first set of apertures defined by the moderator monolith, and
wherein each one of the plurality of first heat pipes is configured to be slidably disposed through a second set of apertures defined by the moderator monolith;
a reflector surrounding the moderator monolith;
a heat transfer material internally throughout the moderator monolith to surround the plurality of fuel rods and the plurality of first heat pipes with the heat transfer material and facilitate heat transfer from the nuclear reactor core to the heat exchanger; and
a container surrounding the reflector; and

12. The nuclear reactor of claim 11, wherein the nuclear reactor core further comprises a plurality of moderator rods configured to be slidably disposed through a third set of apertures in the moderator monolith.

13. The nuclear reactor of claim 11, wherein the heat transfer material is a two state material.

14. The nuclear reactor of claim 13, wherein in a first state of the nuclear reactor the heat transfer material is in a solid state to lock the plurality of fuel rods and the plurality of first heat pipes in place, and in a second state of the nuclear reactor, the heat transfer material is in a liquid state.

15. The nuclear reactor of claim 13, wherein the two state material is lead.

16. The nuclear reactor of claim 11, wherein the plurality of first heat pipes extend into the heat exchanger farther than the plurality of second heat pipes.

17. The nuclear reactor of claim 11, wherein the reflector comprises a plurality of control drums.

18. The nuclear reactor of claim 11, wherein the moderator monolith comprises a unit cell.

19. The nuclear reactor of claim 11, further comprising:
a control rod drive mechanism disposed distal to the heat exchanger, wherein the control rod drive mechanism is configured to drive a control rod through the heat exchanger to the nuclear reactor core.

20. The nuclear reactor of claim 11, wherein the heat exchanger is a first heat exchanger, and wherein the nuclear reactor further comprises a second heat exchanger disposed proximal to the nuclear reactor core and distally from the first heat exchanger.
